(19) United States
(12) Patent Application Publication
(10) Pub. No.: US 2026/0175960 A1
(43) Pub. Date: Jun. 25, 2026

(54) QUICK CONNECTOR SYSTEM, AIRCRAFT CARGO COMPARTMENT, AIRCRAFT, AND METHOD FOR RECONFIGURING AN AIRCRAFT CARGO COMPARTMENT

(71) Applicant: TELAIR INTERNATIONAL GMBH, Miesbach (DE)

(72) Inventor: Richard HOLZNER, Stephanskirchen (DE)

(21) Appl. No.: 19/426,749

(22) Filed: Dec. 19, 2025

(30) Foreign Application Priority Data
Dec. 19, 2024 (DE) 102024138939.7

(51) Int. Cl. B64C 1/22; B64D 9/00

(52) U.S. Cl. CPC B64C 1/22; B64D 9/003

(57) ABSTRACT

A quick connection system for fastening and/or changing components, in particular cargo system components and/or covers, of an aircraft cargo compartment on at least one structural part of an aircraft structure. The quick connection system includes at least one fastening pin having a pin longitudinal axis and installable on the structural part, at least one connecting area on the component and having at least one passage opening configured to accommodate the fastening pin and forming a first form fit in a pin longitudinal axis direction and/or transversely to the pin longitudinal axis, and at least one locking mechanism arranged on the component having at least one engagement element. The locking mechanism is movably mounted on the component such that, by a translational or rotational movement of the engagement element, a second form fit is formed, which blocks a movement of the component relative to the pin longitudinal axis.

### CROSS REFERENCE TO RELATED APPLICATIONS

This application claims priority to German Patent Application No. 102024138939.7, filed Dec. 19, 2024. The disclosure set forth in the referenced application is incorporated herein by reference in its entirety.

FIELD OF THE DISCLOSURE

The invention relates to a quick connection system, a cargo compartment for an aircraft, an aircraft having such a cargo compartment, and a method for reconfiguring such a cargo compartment.

### BACKGROUND

It is known that cargo compartments for aircraft often have to be reconfigured for different intended uses. In particular, there is the challenge for passenger aircraft of loading, for example, only bulk (loose pieces of baggage) or only containers depending on the airports served and the infrastructure thereof. In this context, a rapid reconfigurability between a flat loading floor and a cargo loading system for containers is helpful in order to ensure effective loading and unloading.

Lateral guides mounted on the cargo deck, which each extend in the longitudinal direction of the cargo deck in the area of a side wall of the aircraft, are used for holding and guiding such pieces of cargo. To move the pieces of cargo quickly and easily in the longitudinal direction of the cargo deck, for example, during a loading or unloading procedure, roller conveyors having rotatable rollers arranged at specific intervals in succession are often used. Such roller conveyors can comprise PDUs, so-called “power drive units”, bars, etc. The cargo deck can furthermore have a large number of further cargo system components.

For the optimum utilization of a cargo deck, it is necessary to offer a large number of configuration options, wherein rapid reconfiguring of a deck, for example, a cargo deck or main deck, has a high priority. It is known from the prior art that seat rails or fittings, which are typically present, are used for connection when reconfiguring. Such fittings conventionally comprise an integrated seat rail profile, which is installed on a structural part of the aircraft structure. The components to be installed or changed in the scope of the reconfiguring have matching inserts for locking on the fittings. Such fittings have the disadvantage that an additional structural height of at least 10 to 12 mm is required.

A predetermined height is usually to be maintained starting from the aircraft structure for cargo system components. This can be restricted, for example, to 2 inches, i.e. 50.8 mm. This means that using the system known from the prior art, only approximately 40 mm still remain for the cargo system components in the area of the attachment to the aircraft structure. Subtracting the required free space of fixed components from the system height of approximately 5 mm, only 35 mm effectively still remain. As a consequence, the cargo system components have to be designed more flatly, which is connected to an increase of the weight in order to still be able to absorb the occurring bending loads. In the case of roller conveyors, it can be necessary to mill the roller conveyor profiles out of a solid material as complex and therefore costly components.

A further disadvantage in the use of seat rails or fittings for fastening cargo system components results from the use of additional load-transmitting fasteners, since, for example, seat rails are not designed in all cases for absorbing and transmitting forces introduced by pieces of cargo.

### SUMMARY

The invention is therefore based on the object of specifying a quick connection system for fastening or changing components of an aircraft cargo compartment on at least one structural part of an aircraft structure, which has a reduced weight and a reduced installation space requirement, enables the most efficient possible force dissipation of occurring loads, and enables simple and rapid reconfiguring of the aircraft cargo compartment. The invention is furthermore based on the object of specifying a cargo compartment for an aircraft, an aircraft having such a cargo compartment, and a method for reconfiguring such cargo compartments.

This object is achieved in accordance with the present disclosure.

Specifically, the above-mentioned object is achieved by a quick connection system for fastening and/or changing components, in particular cargo system components and/or covers, of an aircraft cargo compartment on at least one structural part of an aircraft structure, wherein the quick connection system comprises the following:
at least one fastening pin installable on the structural part having a pin longitudinal axis;
at least one connecting area, which is arranged or formed on the component and has at least one passage opening, in which the fastening pin can be accommodated or is accommodated at least in some sections to form a first form fit, in particular a first form fit connection, in the pin longitudinal direction and/or transversely to the pin longitudinal axis direction; and
at least one locking mechanism arranged on the component, having at least one engagement element which is movably mounted on the component such that, by way of a translational or rotational movement of the engagement element with the fastening pin, the structural part, or a mating part installable on the structural part, a second form fit, in particular a second form fit connection, can be formed or is formed, which blocks a movement of the component in the pin longitudinal axis direction and/or transversely to the pin longitudinal axis.

One aspect of the invention is thus to fasten the component on the structural part of the aircraft structure quickly and easily by two formfitting connections formed independently of one another. The first form fit takes place here between the connecting area, which is, for example, an integral part of the component or is firmly connected as a separate part to the component, and the at least one fastening pin. The second form fit takes place between the engagement element of the locking mechanism, which is arranged on the component, and the fastening pin or the structural part itself or a mating part installable on the structural part. The engagement element can be mounted here on a separate retaining part, in particular a retaining web, of the component, in particular so it is translationally displaceable. Alternatively, the engagement element can be mounted, in particular rotationally, on the connecting area of the component.

The quick connection system provides simplified handling of the components during the fastening and changing on the fastening pin by functional separation.

During the fastening, the connecting area of the component is aligned in its position by accommodating the fastening pin in the passage opening. The first form fit is formed here between the connecting area and the fastening pin. The fastening pin is arranged according to a first (preferred) variant of the quick connection system, on the one hand, in a formfitting manner in the passage opening such that a form fit is formed in the pin longitudinal axis direction, in particular a Z direction, and in a first of two transverse directions, in particular an X direction, which extend transversely to the pin longitudinal axis direction. This formfitting direction corresponds here to the first form fit. In the second of the two transverse directions, in particular the Y direction, the connecting area and therefore the component is (still) movable, in particular displaceable, in this state.

In order in the first variant of the quick connection system to block a movement of the component in the second of two transverse directions, in particular in the Y direction, the engagement element of the locking mechanism interacts directly with the structural part or indirectly via the mating part installed on the structural part. The engagement element engages here in the structural part or the mating part such that a displacement of the component in the second transverse direction is prevented. This formfitting direction corresponds here to the second form fit. The engagement of the engagement part in the structural part or the mating part preferably takes place translationally, i.e. by a linear displacement of the engagement element.

If the first and the second form fit are formed, the component is thus locked on the structural part and therefore arranged fixed in position. All, in particular six, degrees of freedom of the component are restricted in this state.

To release the component from the structural part, first the second form fit is released in that the engagement element is displaced in the opposite direction. The connecting area can then be relatively displaced with respect to the fastening pin in the second transverse direction such that the fastening pin can be disengaged. In this state, the connecting area can be raised off of the fastening pin such that this pin can be guided out of the passage opening. In this state, the first and second form fit are canceled, so that the component is freely movable and a component change is possible.

According to a second (further) variant of the quick connection system, the fastening pin is arranged in a formfitting manner in the passage opening such that a form fit is formed in both transverse directions, in particular an X direction and a Y direction, which extend transversely to the pin longitudinal axis direction. This formfitting connection corresponds here to the first form fit. The connecting area and therefore the component is movable, in particular displaceable, in the pin longitudinal direction, in particular the Z direction, in this state.

In order to block the movement in the pin longitudinal axis direction, in particular in the Z direction, in the second variant of the quick connection system, the engagement element of the locking mechanism interacts, preferably directly, with the fastening pin. The engagement element accommodates the fastening pin here, in particular transversely to the pin longitudinal axis, such that a displacement of the component in the pin longitudinal axis direction is prevented. This formfitting connection corresponds here to the second form fit. The engagement of the engagement element in the structural part or the mating part preferably takes place rotationally, i.e. by linear movement of the engagement element.

If the first and the second form fit are thus formed, the component is thus locked on the structural part and therefore arranged fixed in position. In this state, all, in particular six, degrees of freedom of the component are restricted.

To release the component from the fastening pin, first the second form fit is released in that the engagement element is rotated in the opposite direction. The connecting area can then be relatively displaced with respect to the fastening pin in the pin longitudinal direction such that the fastening pin is disengaged. In this state, the connecting area can be raised off of the fastening pin such that this pin can be guided out of the passage opening of the connecting area. In this state, the first and second form fit are canceled, so that the component is freely movable.

The fastening pin is designed as connectable to the structural part of the aircraft structure. The structural part conventionally has predetermined fastening areas. These fastening areas preferably comprise a large number of passage openings, which are formed, for example, as holes. The passage openings form attachment points for the fastening pin. The fastening pin is fastened on an attachment point during the installation and preferably directly connected to the structural part. This can be carried out by a screw connection, in which the fastening pin is screwed directly into the structural part, or by a screw-nut connection. Other types of fastening for connecting the fastening pin to the structural part are possible. The fastening pin, preferably several of the fastening pin, is/are preferably installed directly on the screwing-on points present on the structural part, which are typically provided for fastening permanently installed cargo system components.

The quick connection system particularly preferably comprises a plurality of the fastening pins, which are each connected at one of the attachment points to the structural part.

The installation of the fastening pin on the structural part has the advantage that the loads occurring on the component, for example, during a loading and unloading procedure or when securing the cargo, can be dissipated in an improved manner, or preferably directly into the aircraft structure. In contrast to the prior art, in the invention the use of additional load-transmitting fasteners for relieving seat rails or fittings can be omitted.

Furthermore, the (direct) connection of the fastening pin to the structural part has the advantage that a structural height of the entire system is not reduced or is only slightly reduced, since the components are seated in a depression in the cargo compartment floor or the component-side fastening is an integral part of the component and no additional height or installation space is required for a typical installation fitting. This enables standardized components to be used. In particular, it is advantageous in the fastening of roller conveyors on the structural part that they have more structural height available and are therefore reduced in weight with optimum stability.

The connecting area is preferably an element having a support surface or planar support on the structural part or a support plate which is arranged in the installed state between the support surface and the structural part. The connecting area preferably forms a flange on the component which is formed on a side of the component located on the bottom in the installed attitude. The flange preferably protrudes laterally from the component, so that a winglike connecting area is formed. This is preferably the case if the component is designed as a roller conveyor, wherein the flange protrudes laterally from a roller conveyor profile.

Alternatively, the connecting area can be formed as a support surface on an underside of the component. For example, this can be the case if the component is designed as a cover or cover plate.

Therefore, the quick connection system according to the invention provides a solution which enables a rapid and simple reconfiguration or refitting of a cargo compartment or cargo deck. For example, a change from a cargo compartment having a flat floor (“bulk configuration”) to a cargo compartment having a cargo loading system and vice versa is implementable by the quick connection system. It is possible that the quick connection system can also be used in the main deck in addition to the cargo deck if, for example, a reconfiguration of the main deck from passenger transport to cargo transport is to be implemented. The quick connection system is therefore usable in a variety of ways.

In the scope of the invention, the blocking in one of two transverse directions is to be understood as blocking of the component in both X directions or both Y directions. Furthermore, the blocking in both transverse directions is to be understood as blocking of the component in both X directions and both Y directions. Blocking of the movement of the component in the pin longitudinal axis direction relates to one of two Z directions, since the component rests directly or indirectly on a structural part via the connecting area in the installed state and therefore blocking takes place downward, in particular the further of the two Z directions, via the aircraft structure.

A Cartesian coordinate system is typically used to provide individual directional specifications within an aircraft. In this case, the X axis extends from the tail to the bow, the Y axis extends transversely to the X axis and lies essentially in the plane spanned by the wings. The Z axis is perpendicular to the X and Y axes. The pin longitudinal axis is preferably parallel to the Z axis. Therefore, the Z direction preferably extends parallel to the Z axis. The X direction extends, for example, parallel to the X axis and the Y direction extends parallel to the Y axis. In the directional specification relating to the first and second form fit, the pin longitudinal axis direction extends perpendicularly to the X and Y directions. The X and Y directions extend in a plane which is perpendicular to the pin longitudinal axis. This plane does not necessarily have to extends parallel to the X and Y axes of the aircraft.

Preferred embodiments of the invention are disclosed herein.

In one particularly preferred embodiment, the fastening pin has an elongated base body having at least one retaining section, which protrudes transversely to the pin longitudinal axis on the base body, in order to form the first form fit with the connecting area or to form the second form fit with the engagement element. In other words, the retaining section forms a protrusion on the base body, which enables it to form a form fit in the pin longitudinal axis direction, in particular the Z direction, by interaction with the connecting area of the component. Or in other words, the retaining section holds the connecting area in the pin longitudinal axis direction when the first form fit is formed. Raising of the component is thus prevented. In addition, the retaining section can form a form fit with the engagement element in the pin longitudinal axis direction. The retaining section holds the engagement element here in the pin longitudinal axis direction when the second form fit is formed, which in turn preferably holds the connecting area in position in the pin longitudinal axis direction. The retaining section is therefore usable in a variety of ways to form a form fit. In particular, the fastening pin is constructed very simply in its shape, so that it is producible with low costs.

The retaining section is preferably formed on a longitudinal end of the base body which is arranged on the side facing toward the cargo compartment in the state installed on the structural part.

The retaining section of the fastening pin preferably comprises at least one collar, which is formed at least partially circumferentially in relation to the pin longitudinal axis. The collar is preferably formed completely circumferentially on the base body. This has the advantage that the largest possible support surface is provided to form a form fit, in particular the first or second form fit, in the pin longitudinal axis direction, which increases the stability of the formfitting connection. Furthermore, it is thus possible to dissipate load-related forces via the fastening pin into the structural part.

Furthermore, the base body preferably comprises a guide section, which is adjacent to the retaining section, in particular is located underneath that in the pin longitudinal axis direction, and has a lesser width than the retaining section. The guide section of lesser width enables, on the one hand, the formation of the first form fit by corresponding formation of the passage opening of the connecting area and, on the other hand, the engagement of the engagement element by rotational movement. The base body is preferably formed mushroom-shaped. The retaining section and the guide section preferably each have an external diameter, wherein the external diameter of the retaining section is greater than the external diameter of the guide section. The passage opening of the connecting area is advantageously adapted to accommodate the retaining section and/or at least a portion of the base body while forming the first form fit.

The fastening pin 11 preferably is or several of the fastening pins 11 are fastened directly with or on the structural part 103 by screws in the installed state. The fastening pin or pins 11 can be screwed together with or on the structural part by at least one screw. The screw can be a countersunk screw.

In one particularly preferred embodiment, the passage opening of the connecting area has a first opening area and an adjacent second opening area, which merge into one another, wherein the first opening area is formed so that the retaining section of the fastening pin can be guided through and the second opening area is formed so that the retaining section protrudes outward beyond the second opening area in the accommodated state. In other words, the second opening area has a smaller opening cross section than the first opening cross section. Or in other words, the second opening area is formed narrower than the first opening area. The passage opening is thus preferably designed in the form of a keyhole.

It is particularly advantageous if the first opening area comprises an internal contour, in particular an internal diameter, which is substantially larger than an external contour, in particular the external diameter, of the retaining section of the fastening pin and the second opening area comprises an internal contour which is smaller than the external contour of the retaining section, in particular larger than or essentially equal to an external contour, in particular an external diameter, of the guide section. This enables the connecting area to be held on the structural part, since the retaining section covers the connecting area adjacent to the second opening area and thus forms a form fit in the pin longitudinal axis direction. In addition, the second opening area delimits the guide section in the first transverse direction, in particular the X direction, so that the first form fit is formed.

The seating section is adjacent to the guide section and preferably protrudes at least partially beyond the guide section transversely to the pin longitudinal axis.

The seating section can be formed as a further collar of the base body, which extends around the base body at least in some sections, in particular completely, with respect to the pin longitudinal axis. The seating section can fulfill a retaining and centering function for the pin installation. The guide section can form a circumferential groove in the base body between the retaining section and the seating section.

Alternatively, the passage opening of the connecting area can be designed as an elongated hole. It is possible that the passage opening is a completely closed elongated hole. Alternatively, the passage opening can be an elongated hole open on one side, so that the fastening pin can be pushed into the passage opening by being pushed on laterally. The passage opening can be designed in this case so that the retaining section, in the accommodated state of the fastening pin, covers the connecting area adjacent to the passage opening and therefore holds the connecting area in the pin longitudinal axis direction. In addition, the passage opening is designed here so that it delimits the fastening pin, in particular the guide section in the first transverse direction, in particular the X direction.

In one preferred embodiment, the engagement element is adapted to engage in an opening of the structural part and/or a mating part installable on the structural part while forming the second form fit. If the first form fit is established, the connecting area and therefore the component is aligned in its end position. In the end position, the opening of the structural part or the mating part is opposite to the engagement element such that the engagement element can engage, preferably by a translational movement. Alternatively or additionally, the engagement element can engage in the opening by a rotational or pivoting movement. In order to lock this end position of the component, the second form fit is established in that the engagement element is moved so that it protrudes into the opening. For example, a movement of the component in the second transverse direction, in particular the Y direction, is blocked by the engagement of the engagement element in the opening. This corresponds to a locked and fastened state of the component on the structural part of the aircraft structure, specifically in its end position. A particularly stable formfitting connection is implemented by the provision of a simple opening in the structural part or the mating part.

The engagement element is particularly preferably formed bolt-shaped and is guided so it is translationally displaceable in a retaining part of the component. The engagement element is preferably designed as cylindrical. The opening of the structural part or the mating part can be cylindrical. The opening and the engagement element correspond in the end position of the component.

The engagement element can be a pin which is longitudinally displaceable in or on the component. The retaining part can extend between two roller conveyor profiles, wherein in this case the component is a roller conveyor. The bolt-shaped engagement element is stable and producible cost-effectively. Furthermore, a locking mechanism designed in such a manner is failsafe, since it is very simply constructed and robust.

In a further preferred embodiment, the locking mechanism comprises a lever, which is rotatably connected to the engagement element, wherein the lever, in a first lever position, raises the engagement element to release the second form fit, in particular transversely to the pin longitudinal axis direction or in the second transverse direction, and in a second lever position, lowers the engagement element to form the second form fit, in particular transversely to the pin longitudinal axis direction or in the second transverse direction. The lever is preferably a pivot lever which is pivotable between the two lever positions. The second form fit for locking the end position of the component can be established quickly and easily and also released again by the lever.

The lever is preferably designed such that, in the first lever position, it interacts in a self-inhibiting manner with the retaining part of the component. For this purpose, the lever can have a lever contour in contact with the retaining part, which, in the first lever position, interacts flatly with the retaining part and, in the second lever position, is essentially in rolling contact, in particular in linear contact, with the retaining part. In the first lever position, the lever is preferably arranged essentially upright, in particular extending in the Z direction. In the second lever position, the lever is preferably arranged essentially recumbent, in particular extending in a direction transverse to the Z direction.

According to one embodiment, the locking mechanism has a rotating handle, which is connected, in particular in a rotationally-fixed manner, to the engagement element, wherein the rotating handle, in a first handle position, raises the engagement element to release the second form fit, in particular transversely to the pin longitudinal axis direction and, in a second handle position, lowers the engagement element to form the second form fit, in particular transversely to the pin longitudinal axis direction. The rotating handle is preferably rotatable around the axis of rotation coaxial to a center longitudinal axis of the engagement element. In other words, the engagement element preferably has a center longitudinal axis which in particular extends parallel to the pin longitudinal axis direction, and around which the rotatable handle is rotatable. The axis of rotation preferably extends perpendicularly, in particular vertically, in relation to the rotational direction of the rotating handle. By rotating the rotating handle around axis of rotation, the rotating handle is preferably adjustable between the two handle positions. The second form fit for locking the end position of the component can be established and also released again quickly and easily by the rotating handle.

In the first handle position, the rotating handle can be pivoted around the axis of rotation by 90° in relation to the retaining part. In the second handle position, the rotating handle can be aligned corresponding in direction with the retaining part. In other words, the rotating handle, in the first handle position, in which the engagement element is raised up, can be located in a 0 position, in particular a starting position, and in the second handle position, in which the engagement element is lowered, it can be located in a position rotated by 90° in relation to the 0 position. The rotational angle range for raising and lowering the engagement element is preferably 0° to 90° (around the axis of rotation).

The locking mechanism preferably comprises at least one extension having a protruding upper edge, in particular in the pin longitudinal axis direction, which holds the rotating handle raised in its first handle position, and has at least one surface 56 set back from the upper edge, on which the rotating handle rests lowered into its second handle position. The extension and/or the set-back surface 56 are preferably part of the retaining part. It is advantageous here that securing the rotating handle in its respective position is enabled by a simple constructive design.

The rotating handle is preferably designed such that, in the first handle position, it interacts with the extension, in particular while causing a spring pre-tension of the rotating handle against the upper edge of the extension. The rotating handle can have a handle surface, which is in contact with the upper edge of the extension, faces toward the engagement element, interacts in the first handle position with the upper edge, and rests in the second handle position on the set-back surface 56.

The locking element preferably comprises at least one spring element, which pre-tensions the engagement element, if the lever is present, in a direction facing away from the lever when the lever is located in its first lever position. The spring element has the advantage that it assists the transfer of the lever from the first into the second lever position by spring force and secures the second form fit with the opening of the structural part or the mating part. The spring element presses the engagement element into the opening in the engaged position. The second form fit and therefore the locking of the component in its end position is thus ensured.

If the rotating handle is present, the locking mechanism preferably comprises at least one spring element, which pre-tensions the engagement element in a direction facing away from the rotating handle when the rotating handle is located in its first handle position. The spring element has the advantage that it pre-tensions the rotating handle against the upper edge of the extension and therefore the rotating handle is held, in particular in a friction-locked manner, on the upper edge. Furthermore, the spring element has the effect that it securely holds the second form fit in the opening of the structural part or the mating part. The spring element presses the engagement element into the opening in the engaged position. The second form fit and therefore the locking of the component in its end position is thus ensured.

The spring element is preferably integrated into the retaining part and supports itself against it. The retaining part preferably forms a buttress for the spring element, in order to pre-tension the engagement element in the first lever position or first handle position in the direction of the opening of the structural part or mating part.

This spring element can comprise at least one coil spring. It is alternatively possible that the spring element comprises at least one conical compression spring. Other spring types are possible as the spring element.

In a further embodiment, the locking mechanism has at least one link mounted to be rotationally movable, which is coupled with the engagement element such that it causes raising or lowering of the engagement element by a rotational movement. The raising and lowering of the engagement element is implemented in this case by a rotational lever movement via the link.

In one preferred embodiment, the quick connection system has at least one support plate and/or at least one bottom plate, in particular a bottom cover, for the support of the component, which comprises at least one passage opening for the fastening pin. The support plate and/or bottom plate can be used as a positioning aid for the fastening pin. The support plate and/or bottom plate preferably has at least one prefinished exact hole, into which the fastening pin is inserted. The support plate and/or bottom plate offer protection for the structural part, for example, a crossbeam of the aircraft structure, on the one hand. The support plate and/or bottom plate does slightly reduce the remaining system height, but offers advantages with respect to the installation due to the predetermined positioning aid for the fastening pin.

The support plate and/or bottom plate preferably has several holes for several of the fastening pins. The support plate or the bottom plate preferably has at least two, at least four, at least six, or at least eight holes. The quick connection system preferably has at least two, at least four, at least six, or at least eight of the fastening pins. In the fastening state, each one of the holes is assigned to one of the fastening pins or such a fastening pin is arranged in a hole. The holes and therefore the number of the fastening pins are usually predetermined by the aircraft structure or matched thereto in this case.

The support plate and/or bottom plate is preferably formed thin. The support plate and/or bottom plate preferably has a thickness in the area of the passage opening for the fastening pin of 1 mm to 8 mm, in particular 1 mm to 6 mm or 1 mm to 4 mm, particularly preferably 1 mm to 3 mm.

The desired height in the installed position of the fastening pin can be set via the support plate.

If the support plate is omitted, exact positioning of the fastening pin can be performed during the installation by means of a positioning gauge and if needed by using shims. It is possible that in this case the height setting of the fastening pin is carried out via one or more support sheets.

The passage opening of the support plate or the bottom plate preferably has at least one shoulder and the fastening pin has at least one seating section, which rests on the shoulder and is accommodated in a formfitting manner by the passage opening. In other words, the fastening pin is supported via the seating section on the shoulder, wherein the seating section is circumferentially delimited, in particular completely, with respect to the pin longitudinal axis by the passage opening. It is advantageous here that a planar introduction of force takes place from the fastening pin via the shoulder into the support plate or the bottom plate and further into the structural part. Furthermore, the support plate or the bottom plate laterally supports the seating section, so that forces can also be absorbed and dissipated efficiently in the X and Y directions.

In one preferred embodiment, the passage opening of the connecting area comprises an internal contour, in particular an internal diameter, which essentially corresponds to an external contour, in particular an external diameter, of the seating section and/or the retaining section of the fastening pin. This has the advantage that the first form fit takes place in both transverse direction, in particular in the X and Y directions, with respect to the pin longitudinal direction. Furthermore, the connecting area can be placed on the fastening pin in order to then lock it on the fastening pin.

The internal contour of the passage opening the connecting area is preferably formed complementary to the external contour of the guide section. Additionally or alternatively, the internal contour of the passage opening of the connecting area can be formed complementary to the external contour of the retaining section. The internal contour of the passage opening of the connecting area can have a slight excess in relation to the external contour of the guide section and/or the retaining pin in order to ensure the accommodation of the fastening pin. The passage opening of the connecting area is preferably formed circular.

The mating part for engaging the engagement part is particularly preferably part of the support plate. The mating part can be integrally formed with the support plate. In other words, the mating part and the support plate can be formed in one piece. This results in a very stable structure. Alternatively, the mating part can be formed as a separate part which is firmly connected to the support plate. Furthermore, the mating part can alternatively be provided independently of the support plate, in particular fastened on the structural part or the bottom plate. The mating part is preferably arranged in this case in the vicinity of the at least one fastening pin, in particular the multiple fastening pins. The mating part is used to form the second form fit by engaging the engagement element of the locking mechanism. The mating part is preferably arranged in the center area of the support plate.

The mating part preferably has a retaining lug, which is offset from a lower side of the mating part and laterally forms a protrusion. In the installed state of the support plate or the mating part on the structural part, a distance is formed between the retaining lug and the structural part, in which an engagement element of a component, for example, a cover, can engage for releasable locking.

If the support plate should be omitted, the mating part as such can be fastened on the structural part or the bottom plate in order to implement engagement of the engagement element.

The support plate or the bottom plate can additionally have at least one rail section, in particular a perforated rail section, to form a tiedown point or positioning fitting, which is arranged in the area of the opening of the mating part. The rail section is preferably formed in a center area of the support plate or the bottom plate. This enables the formation of multiple passage openings for multiple fastening pins on both sides of the rail section, so that a solid, stable attachment point is provided. The rail section preferably extends along the structural part, i.e. in the Y direction. The rail section is particularly preferably adjacent to the mating part.

In one preferred embodiment, the retaining section and/or guide section of the fastening pin are formed in one piece with the base body of the fastening pin. Alternatively, the retaining section and/or the guide section of the fastening pin are preferably part of a sleeve separate from the base body. The multipart embodiment has the advantage that the fastening pin is producible easily and cost-effectively.

The sleeve can be an independent component which can be arranged or is arranged on the base body of the fastening pin. The sleeve can then become or be pushed onto the elongated base body. In other words, the elongated base body can be inserted into the sleeve. Alternatively, the sleeve, if it is formed as an independent component, can be preinstalled on the support plate, wherein the passage opening of the support plate for the elongated base body of the fastening pin extends in a passage of the sleeve. The fastening pin is inserted here during the installation with its elongated base body into the preinstalled sleeve.

Alternatively, the sleeve can be an integral part of the support plate, wherein the passage opening of the support plate for the elongated base body of the fastening pin extends through the sleeve. The sleeve is then integrated into the support plate, but is still part of the fastening pin.

In the multipart embodiment of the fastening pin, the elongated body can be a screw, for example, a panhead screw or a countersunk screw. Other types of screw are possible.

In one preferred embodiment, the engagement element is arranged between the connecting area and the retaining section and is adapted to engage behind the retaining section by way of a rotational movement while forming the second form fit. In other words, the connecting area of the component is preferably located between the retaining section and the engagement element. This is the case if the connecting area is already placed on the fastening pin and is accommodated in a formfitting manner in the passage opening. The first form fit is thus formed, which preferably blocks a movement of the connecting area and therefore the component in both transverse directions, i.e. in the X and Y directions. The engagement element is thus used here not only for locking the component in its end position, but also for holding the component in the pin longitudinal axis direction, i.e. in the Z direction. The engagement element fixes the connecting area on the structural part, in particular the support plate, which is in turn firmly connected to the structural part. In this embodiment, a twist closure is thus formed, wherein the second form fit is implementable by a simple rotational movement of the engagement element.

The engagement element is preferably formed disc-shaped and has a curved opening, which comprises a first opening section that is larger than an external contour of the retaining section of the fastening pin, and which has a second adjacent opening section that is smaller than the external contour of the retaining section. The curved opening is in other words preferably formed by a keyhole opening extending in a curve. Alternatively, similarly as in the passage opening of the connecting area, the curved opening can be formed by a laterally open oblong hole extending in a curve in the present case. The retaining section of the fastening pin can be guided through the first opening section. By rotating the disc-shaped engagement element, the engagement element engages in the second opening section by the retraction of the guide section. In other words, the retaining section overlaps the engagement element in the area of the second opening section when the engagement element is in the locking position. The second form fit is thus implemented in the pin longitudinal direction in a simple manner.

The engagement element is preferably rotatable around an axis of rotation which extends parallel to the pin longitudinal axis, wherein the engagement element releases the fastening pin in a first rotational position to release the second form fit, in particular in the pin longitudinal axis direction, and holds it in a formfitting manner in a second rotational position to form the second form fit, in particular in the pin longitudinal axis direction.

In one preferred embodiment, the component is a roller conveyor or a cover, wherein the roller conveyor preferably has multiple rotatably mounted rollers and at least one latch and/or one PDU. The connecting area and the locking mechanism can be provided on the roller conveyor and on the cover. Other components for fastening on the structural part of the aircraft structure are possible.

According to another independent aspect, the invention relates to a cargo compartment for an aircraft having at least two frames, which have a distance from one another in the longitudinal direction of the cargo compartment, and at least two crossbeams forming structural parts, wherein each one of the crossbeams extends on one of the frames transversely to the longitudinal direction of the cargo compartment, and at least one component, in particular a cargo system component and/or cover, wherein a quick connection system in accordance with the present disclosure is provided, by which the component is releasably connected to at least one of the crossbeams.

The component is preferably releasably fastened on both crossbeams by the quick connection system. The support plate and/or the fastening pin is particularly preferably fastened resting on a surface of one or both crossbeams facing toward the cargo compartment. This also applies for the mating part for accommodating the engagement element. Furthermore, the crossbeams preferably have predefined fastening areas. These fastening areas preferably comprise a large number of passage openings, which are formed as holes, for example. The passage openings form attachment points for multiple fastening pins. The fastening pins are fastened on the attachment points during the installation and preferably connected directly to the structural part. This can be carried out by a screw connection, in which the fastening pins are screwed directly into the structural part, or by a screw-nut connection. Other types of fastening for connecting the fastening pins to the structural part are possible.

According to another independent aspect, the invention relates to an aircraft having such a cargo compartment.

In a method according to the invention for reconfiguring or refitting such a cargo compartment, at least one quick connection system according to the invention is used, wherein the component is in a state locked with the structural part, wherein the engagement element is moved away from the mating part or the structural part of the aircraft by a translational or rotational movement such that it is moved into an unlocked position to release the second form fit. The component, for example, a roller conveyor, is then moved into a release position by displacing the connecting area and the connecting area is removed from the fastening pin. A further component is then placed on the at least one fastening pin and the engagement element of the locking mechanism of the further component, for example, a cover, is fastened in a formfitting manner with the mating part or the structural part by a rotational movement of the engagement element.

In a further method according to the invention for reconfiguring or refitting such a cargo compartment, at least one quick connection system according to the invention, wherein the component is in a state locked with the structural part, wherein the engagement element is moved in relation to the fastening pin by a rotational movement such that it is moved into an unlocked position to release the second form fit and the component is thus located in a release position. The connecting area of the component is then removed from the fastening pin. A further component is then placed on the at least one fastening pin and the engagement element of the locking mechanism of the further component is fastened in a formfitting manner to the mating part or the structural part of the aircraft by a rotational movement of the engagement element.

The components to be changed are equipped with a connecting area and a locking mechanism of the quick connection system according to the invention.

If a change of the component is to be completed, the above-described method steps are carried out in reverse sequence.

Reference is made to the advantages explained in conjunction with the quick connection system for the advantages of the cargo compartment, the aircraft, and the method for reconfiguring. In addition, the cargo compartment, the aircraft, and the method for reconfiguring can alternatively or additionally have individual features or a combination of several features previously mentioned with reference to the quick connection system.

### BRIEF DESCRIPTION OF THE DRAWINGS

The invention is explained in more detail hereinafter with further details with reference to the appended drawings. The embodiments shown represent examples of how the quick connection system according to the invention or the cargo compartment according to the invention can be designed.

In these figures,

FIG. 1 shows an exploded view of a quick connection system according to a preferred exemplary embodiment according to the invention;

FIG. 2 shows a top view of the quick connection system from FIG. 1, wherein a line of section B-B through the quick connection system is shown;

FIG. 3 shows a section along the line of section B-B from FIG. 2, wherein the engagement element engages in the mating part;

FIG. 4 shows a section along the line of section B-B from FIG. 2, wherein the engagement element is disengaged from the mating part;

FIG. 5 shows a top view of the quick connection system from FIG. 1, wherein a line of section C-C through the quick connection system is shown;

FIG. 6 shows a section along the line of section C-C from FIG. 5, wherein the lever is in a first lever position;

FIG. 7 shows a lateral view of a fastening pin of the quick connection system from FIGS. 1 and 7;

FIG. 8 shows a top view of a roller conveyor as a component, which has multiple connecting areas for fastening with the fastening pin;

FIG. 9 shows a top view of a quick connection system according to a further exemplary embodiment according to the invention, wherein a line of section A-A through the quick connection system is shown;

FIG. 10 shows a section along the line of section A-A from FIG. 9;

FIG. 11 shows a top view of the quick connection system from FIG. 9, in which the engagement element is in a locking position;

FIG. 12 shows a partial view of a cargo compartment having multiple quick connection systems according to a further exemplary embodiment according to the invention;

FIG. 13 shows a detailed view of the cargo compartment in the area of one of the quick connection systems from FIG. 12;

FIG. 14 shows a bottom view of a cover as a component having a locking mechanism and a connecting area of the quick connection system from FIG. 13;

FIG. 15a, b show a respective longitudinal section through an alternative fastening pin for the quick connection system from FIG. 1;

FIG. 16 shows a perspective view of a support plate having several of the fastening pins from FIG. 15a;

FIG. 17 shows a perspective view of a support plate of a quick connection system according to a further exemplary embodiment according to the invention;

FIG. 18 shows a perspective view of a support plate of a quick connection system according to a further exemplary embodiment according to the invention;

FIG. 19 shows a perspective view of a locking mechanism in the unlocked state of a quick connection system according to a further exemplary embodiment according to the invention;

FIG. 20 shows a cross section through the locking mechanism from FIG. 19;

FIG. 21 shows a perspective view of the locking mechanism from FIG. 19 in the locked state;

FIG. 22 shows a cross section through the locking mechanism from FIG. 20;

FIG. 23 shows a perspective top view of a bottom plate having multiple mating parts for connection to the locking mechanisms of quick connection systems according to the invention;

FIG. 24 shows a perspective view of a support plate of a quick connection system according to a further exemplary embodiment according to the invention; and

FIG. 25 shows a perspective view of a latch device as a component and having a quick connection system from FIG. 24.

The same reference signs are used in the following description for identical and identically-acting parts.

### DETAILED DESCRIPTION

A Cartesian coordinate system is typically used to provide individual directional specifications within an aircraft. In this case, the X axis extends from the tail to the bow, the Y axis extends transversely to the X axis and lies essentially in the plane spanned by the wings. The Z axis is perpendicular to the X and Y axes.

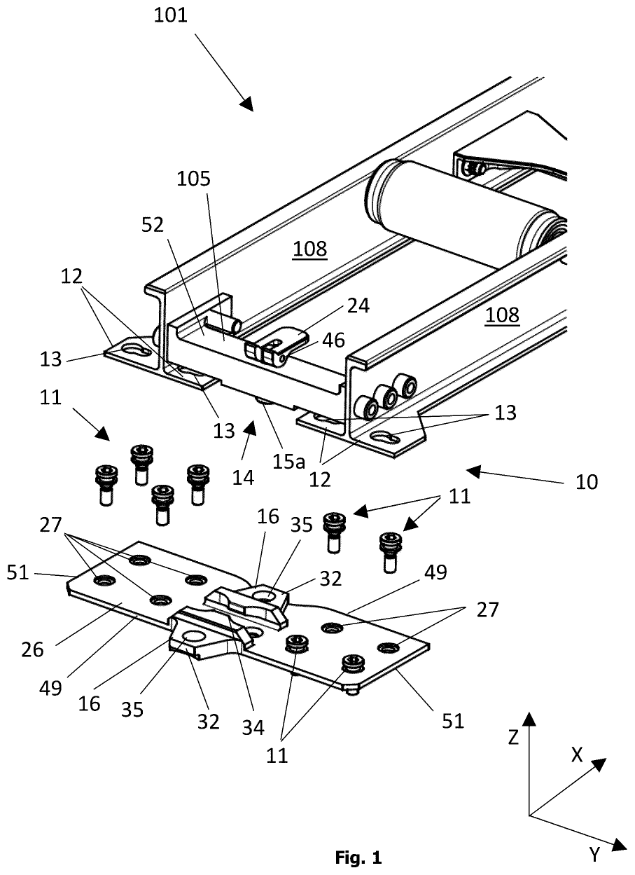

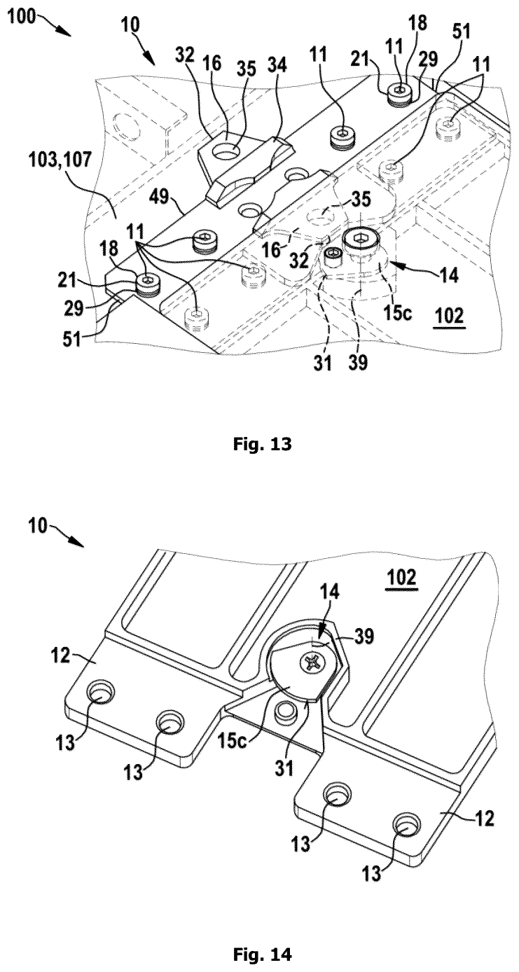

FIGS. 1 to 8 show quick connection system 10 according to a preferred exemplary embodiment according to the invention in order to fasten a component of a cargo compartment 100, in the present case a roller conveyor 101, in a releasable and therefore changeable manner to a structural part 103 of an aircraft structure 104. The aircraft structure 104 and therefore the structural part 103 can be seen in FIGS. 12 and 13.

The quick connection system 10 comprises multiple fastening pins 11 each having a pin longitudinal axis LA. The fastening pins 11 each form a separate part for fastening the roller conveyor 101 on the structural part 103. As shown in FIGS. 12 and 13, the structural part 103 is formed by a crossbeam 107, which extends in the Y axial direction between two rising sections of a frame 106. In the installed state, the fastening pins 11 are thus fastened on the crossbeam 107. Specifically, the fastening pins 11 are connected to the crossbeam 107 at predefined attachment points, which comprised a passage opening. This can be carried out by screwing in the fastening pin 11 and/or by a screw-nut connection.

FIG. 7 shows one of the fastening pins 11, which are formed in one piece, as an example, wherein all of them have the same design and shape. The design of the fastening pins 11 will be explained in more detail on the basis of FIG. 7, wherein the following description of the fastening pin 11 applies to all one-piece fastening pins 11.

The fastening pins 11 according to FIG. 7 have an elongated base body 17. The elongated base body 17 comprises a fastening section 41 having an external thread, which extends along the pin longitudinal axis LA. As is apparent, the external thread tapers toward a first longitudinal end 42 of the fastening pin 11. The fastening pin 11 is connected to the crossbeam 107 via the fastening section 41.

Furthermore, the fastening pin 11 has a retaining section 18, which protrudes transversely to the pin longitudinal axis LA on the base body 17. The retaining section 18 is used in the fastened state of the roller conveyor 101 to secure a connecting area 12 of the roller conveyor 101 in a direction parallel to the pin longitudinal axis LA while forming a form fit. This direction is also referred to as the pin longitudinal axis direction, which corresponds to a Z direction. In the present example, the pin longitudinal axis direction extends parallel to the Z direction of the aircraft. The retaining section 18 is arranged at a second longitudinal end 43 of the fastening pin 11. Specifically, the retaining section 18 forms a collar 19, which is formed completely circumferentially with respect to the pin longitudinal axis LA on the base body 17.

The one-piece embodiment of the fastening pin 11 shown permits an optimum structural size at optimum weight. Embodiments are also conceivable in which the fastening is carried out by means of a screw that is passed through, such as a countersunk screw. In this case, however, the required diameter of the fastening pin increases in turn.

Alternatively, it is possible that the fastening pin 11 is formed in two or multiple parts. The diameter of the fastening pin 11 is enlarged here in comparison to the one-piece fastening pin 11. The two-part or multipart embodiment of the fastening pin 11 will be discussed in more detail later.

FIG. 7 furthermore shows a guide section 21 of the fastening pin 11 adjacent to the collar 19. The guide section 21 is formed along the pin longitudinal axis LA adjacent to the collar 19. The guide section 21 is used to guide the connecting area 12 of the roller conveyor 101 during a fastening procedure of the roller conveyor 101. The guide section 21 has a lesser width transverse to the pin longitudinal axis LA than the collar 19.

A seating section 29 of the fastening pin 11 is formed adjacent to the guide section 21. The seating section 29 protrudes beyond the guide section 21 transversely to the pin longitudinal axis LA. The seating section 29 forms a further circumferential collar on the base body. The seating section 29 is used for seating in a passage opening, for example, of a support plate. The seating section 29 and the retaining section 18 have the same width transverse to the pin longitudinal axis LA. Specifically, the seating section 29 and the retaining section 18 protrude transversely to the pin longitudinal axis LA by the same amount transversely beyond the guide section 21.

The guide section 21 is therefore arranged between the retaining section 18 and the seating section 29. Specifically, the guide section 21 forms a circumferential groove around the pin longitudinal axis LA in the base body 17.

As can be seen well in FIG. 1 and FIG. 7, the fastening pin 11 is formed essentially cylindrical. The retaining section 18 and the guide section 21 each have a diameter, wherein the diameter of the retaining section 18 is larger than the diameter of the guide section 21. Likewise, the seating section 29 has a diameter which is larger than the diameter of the guide section 21. It can be seen in FIG. 7 that the retaining section 18 is thicker in the pin longitudinal axis direction than the seating section 29. Furthermore, the guide section 21 is thicker in the pin longitudinal axis direction than the seating section 29.

As shown in FIG. 1, a total of eight fastening pins 11 are provided, wherein four fastening pins 11 are used to attach the roller conveyor 101. The further four fastening pins 11 are used, for example, to attach a further roller conveyor 101 in order to extend the preceding roller conveyor 101.

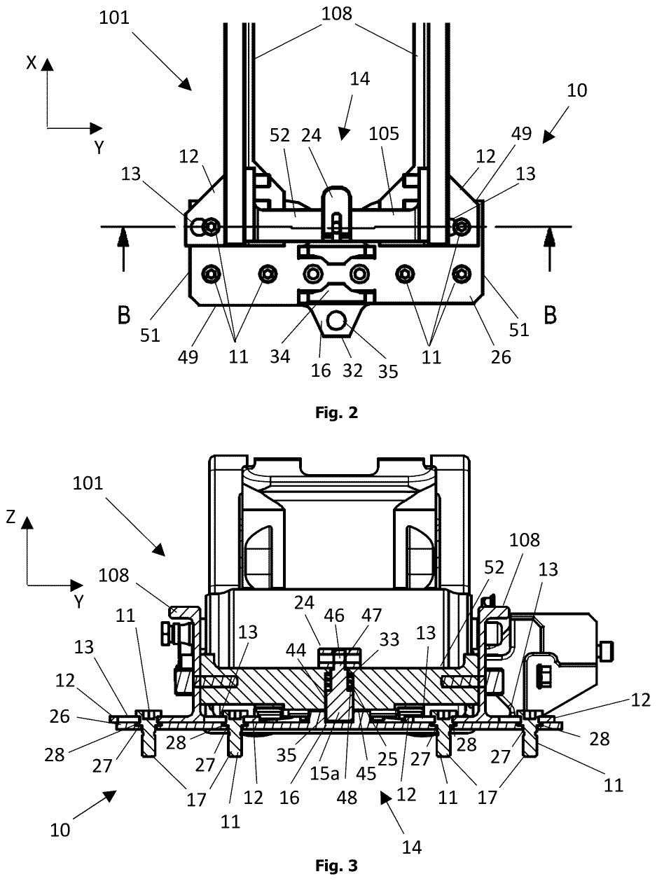

Furthermore, FIGS. 1 to 6 and FIG. 8 show that the quick connection system 10 has multiple connecting areas 12, which have one or more passage openings 13 for accommodating the fastening pins 11. It is clearly visible in FIGS. 1 and 2 that the connecting areas 12 are arranged on a lower side of two roller conveyor profiles 108 arranged opposite. The connecting areas 12 are plate-shaped elements, which extend outward transversely to the longitudinal direction of the roller conveyor 101 on each roller conveyor profile 108. The connecting areas 12 are each formed on the inner side and outer side on the roller conveyor profiles 108. They are part of the roller conveyor profiles 108 and therefore are formed in one piece with them. Each two of the connecting areas 12 are formed like wings on one of the roller conveyor profiles 108. The connecting areas 12 each form an attachment flange for connection to the fastening pins 11.

Each of the connecting areas 12 has, as described, one or more passage openings 13 for the fastening pins 11, in order to form a first form fit with the fastening pins 11.

FIG. 8 shows a top view of one of the two roller conveyor profiles 108, on the basis of which the passage openings 13 are described hereinafter. The passage openings 13 of the connecting area 12 are adapted to lead through the retaining section 18 of the base body 17 and accommodate the guide section 21 of the base body 17 while forming the first form fit.

It can be seen from the figures that the passage openings 13 of the connecting areas 12 are formed in the shape of key holes. The passage openings 13 of the connecting area 12 comprises a first opening area 22 and an adjacent second opening area 23, which merge into one another. The first opening area 22 is formed so that the retaining section 18 of the assigned fastening pin 11 can be guided through and the second opening area 23 is formed so that the retaining section 18 protrudes outward beyond the second opening area 23.

Specifically, the first opening area 22 of the passage openings 13 has an internal diameter which is substantially larger than the diameter of the retaining section 18 of the fastening pin 11. The second opening area 23 has an elongated hole shape, which is open toward the first opening area 22. The width of the second opening area 23, in particular the elongated hole, is smaller than the diameter of the retaining section 18 and larger than or essentially equal to the diameter of the guide section 21. The respective fastening pin 11 can thus be pushed with its retaining section 18 through the first opening area 22 and then the roller conveyor 101 transversely to the pin longitudinal axis LA into the second opening area 23 until the guide section 21 stops on an end of the second opening area 23 opposite to the first opening area 22. FIGS. 2 to 5 clearly show the above-described state, in which the roller conveyor 101 is located at its end position.

In this state, the first form fit is formed between the connecting area 12 and the fastening pin 11. A movement of the roller conveyor 101 is blocked here in one of two directions transversely to the pin longitudinal axis LA, specifically in the X direction, and in the pin longitudinal axis direction, specifically in the Z direction. This means that the first form fit blocks of movement of the roller conveyor 101 in both X directions and in the Z direction. The fastening pin 11 is accommodated in a formfitting manner in the passage opening 13 of the connecting area 12. In other words, a movement of the roller conveyor 101 along the X axis of the aircraft and the Z axis of the aircraft is thus prevented.

Furthermore, it can be seen in FIGS. 5 and 8 that respective opposing passage openings 13 of the connecting areas 12 on the roller conveyor profiles 108 are aligned on a line transversely to the longitudinal direction of the roller conveyor 101. The passage openings 13 extend here transversely to the longitudinal direction of the roller conveyor 101.

To now lock the roller conveyor 101 in its adopted end position while forming a second form fit, a locking mechanism 14 is provided, which is arranged on the roller conveyor 101. The locking mechanism 14 has an engagement element 15a, a lever 24, and a spring element 25. The engagement element 15a is designed in the form of a bolt. In other words, the engagement element 15a is formed cylindrical. Other shapes are possible. The engagement element 15a is guided translationally, thus so it is longitudinally displaceable, in a retaining part 105 of the roller conveyor 101. The retaining part 105 extends transversely to the longitudinal direction of the roller conveyor 101 between the two opposing roller conveyor profiles 108. The retaining part 105 is a web which connects the two roller conveyor profiles 108.

The retaining part 105 has a hole 44, in which the engagement element 15a is guided so it is longitudinally displaceable. The engagement element 15a can emerge from the hole 44 at a lower side 45 of the retaining part 105 and retract back therein. The position of the engagement element 15a is dependent on the position of the lever 24, to which the engagement element 15a is connected via a pivot joint 46. The lever 24 is pivotably mounted on an upper side 52 of the retaining part 105 via the pivot joint. As can be seen in FIG. 16, the lever 24 can adopt two lever positions, which are predetermined by an eccentric shape of a contact surface of the lever 24, via which the lever 24 is in contact with the upper side 102 of the retaining part 105.

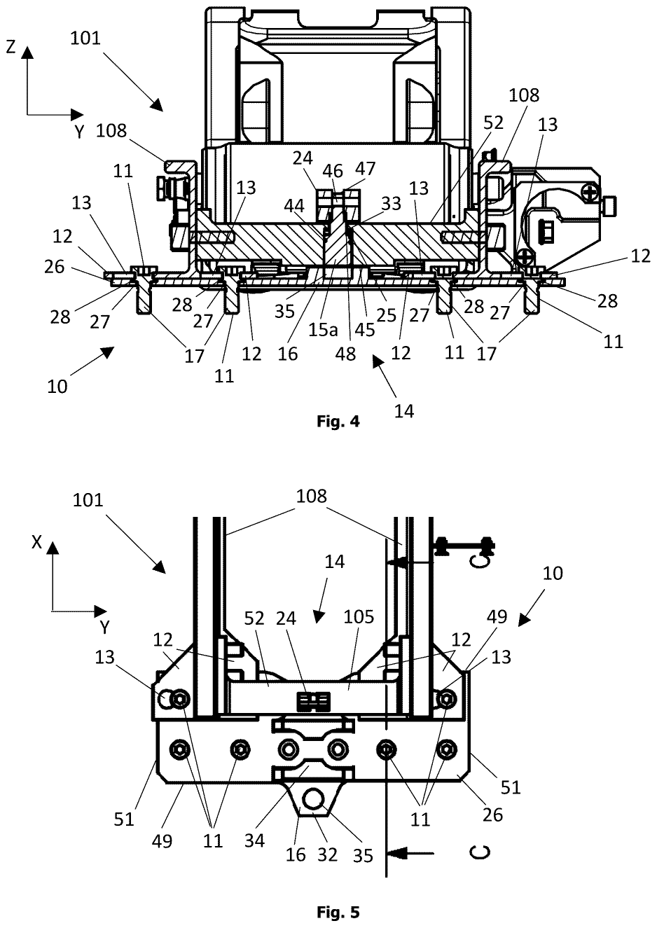

The engagement element 15a has a connecting pin 47, which is guided through a passage of the retaining part 105 toward the upper side 52. Specifically, the pivot joint 46 is located on the portion of the connecting pin 47 protruding over the upper side 52 of the retaining part 105, on which the lever 24 is also arranged. In the hole 44, the engagement element 15a has a further portion, which has a greater width than the connecting pin 47. It is clearly visible in FIGS. 3 and 4 that the engagement element 15a has a shoulder 48. It is also found that the spring element 25 is supported on one side on an inner surface 33 of the hole 44 adjacent to the passage and on the other side on the shoulder 48 of the engagement element 15a.

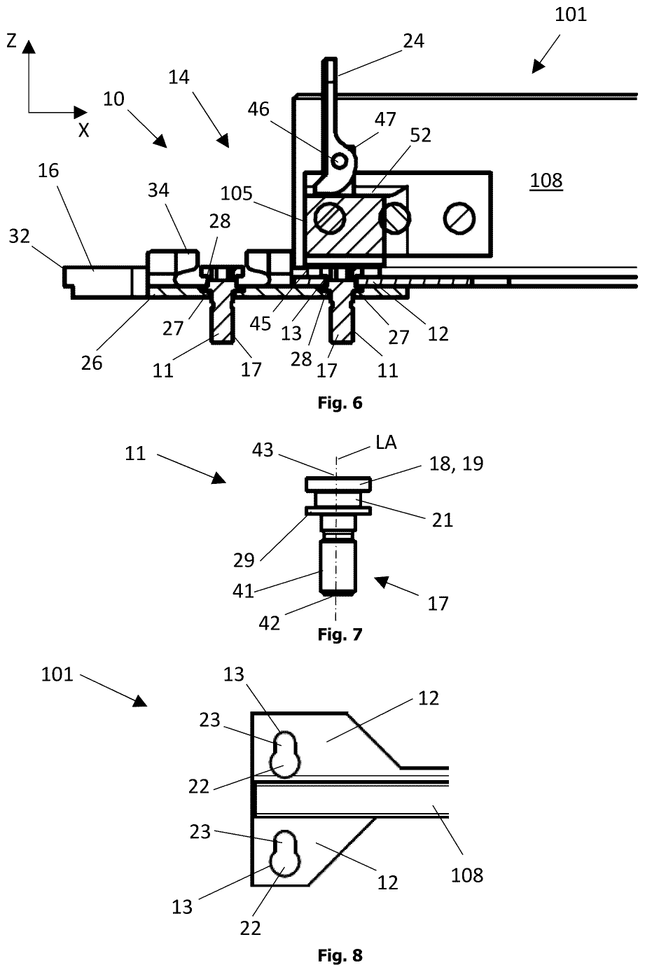

In a first lever position, the lever 24 is arranged upright. As can be seen in FIG. 6, the lever 24 extends essentially perpendicularly to the longitudinal direction of the roller conveyor 101. In the first lever position, the wider portion of the engagement element 15a is completely accommodated in the hole 44, which is shown in FIG. 4. In this position, the spring element 25 is compressed between the shoulder 48 of the engagement element 15a and the inner surface 33 of the hole 44 and thus applies a spring force which pre-tensions the engagement element 15a in the extension direction.

In the first lever position, the engagement element 15a is disengaged from an opening 35 of a mating part 16, with which the second form fit can be formed in order to block a movement of the roller conveyor 101 in the second transverse direction, specifically in the Y direction, and thus lock the roller conveyor 101 in its end position. In the second transverse direction means that the second form fit blocks a movement of the roller conveyor 101 in both Y directions.

Due to the upright position of the lever 24 in the first lever position, the lever 24 presses flatly with a first surface on the upper side 52 of the retaining part 105, wherein the spring force presses the lever 24 against the upper side 52 of the retaining part 105 and the lever 24 is thus independently held in the first lever position. In this way, it is possible to position and install even longer assemblies having multiple such locking mechanisms easily in the aircraft or cargo compartment.

To transfer the lever 24 from the first lever position to a second lever position, it has a curved, in particular eccentric, shape at its longitudinal and in contact with the upper side 52 of the retaining part 105, which merges starting from the first surface into a second surface aligned perpendicularly thereto. These two surfaces and the curved shape form the above-mentioned contact surface. The lever 24 slides over the curved shape during the transfer between the two lever positions. This spring element 25 assists the transfer movement by way of the spring force. The engagement element 15a is lowered due to this curved shape during the transfer from the first into the second lever position, by which the second form fit is formed. In contrast, during the transfer from the second to the first lever position, the engagement element 15a is raised, so that the second form fit is canceled and the roller conveyor 101 is displaceable transversely to the longitudinal direction of the roller conveyor 101 via the keyhole-shaped passage openings 13 of the connecting areas 12.

In the second lever position, the lever 24 is arranged recumbent. As can be seen in FIG. 1, the lever 24 extends essentially in the longitudinal direction of the roller conveyor 101. In the second lever position, the wider portion of the engagement element 15a is extended partially out of the hole 44, as shown in FIG. 3. In this position, the engagement element 15a protrudes into the opening 35 of the mating part 16 and thus forms the second form fit, which ultimately locks the roller conveyor 101.

Due to the recumbent position of the lever 24 in the second lever position, the lever 24 rests flatly with the second surface on the upper side 52 of the retaining part 105, wherein a remaining spring force presses the lever 24 against the upper side 52 of the holding part 105 and the lever 24 is thus held independently in the second lever position. At the same time, the spring element 25 causes the engagement element 15a to remain engaged with the opening 35 of the mating part 16 and thus secures the second form fit.

The locking element 14 can alternatively comprise a link mounted to be rotationally movable, which is coupled with the engagement element 15a such that it causes raising or lowering of the engagement element 15a by a rotational movement. This represents a further option for controlling the engagement element 15a. For example, the link can implement raising or lowering of the engagement element 15a by a 90° rotational movement, for example.

As can be seen in FIGS. 3 and 4, the opening 35 of the mating part 16 corresponds with the engagement element 15a in the end position of the roller conveyor 101. The mating part 16 will be described in more detail later.

Furthermore, it can be seen from FIG. 16 that the quick connection system 10 has a support plate 26 to support the connecting areas 12 of the roller conveyor 101, which comprises one passage opening 27 per fastening pin 11. The fastening pins 11 rest indirectly on the crossbeam 107 via the support plate 26.

The support plate 26 comprises two opposing longitudinal sides 49 and two opposing wide sides 51. Four passage openings 27 of the support plate 26 are arranged on each longitudinal side 49 of the support plate 26. The four passage openings 27 are arranged located on the same line in the longitudinal direction of the support plate 26. The ultimate location of the passage openings 27 is predetermined by the location of the predefined attachment points, in particular screwing-on points, on the structural part 103 of the aircraft structure 104.

The passage openings 27 each have a distance to one another which corresponds to the distance between connecting areas 12 of the roller conveyor 101 arranged adjacent to one another between the passage openings 13 located on a line. The respective number and position of the passage openings 27 depend in this case on the relevant aircraft structure 104, which predetermines the respective attachment points or fastening points.

The support plate 26 has a thickness of 1 mm to 3 mm. The passage openings 27 of the support plate 26 comprise a shoulder 28, on which the fastening pins 11 rest with their seating sections 29. The seating section 29 of the fastening pin 11 is accommodated in a formfitting manner in the respective passage opening 27 such that it terminates flush with an upper surface of the support plate 26. The connecting areas 12 of the roller conveyor 101 thus rest flatly on the support plate 26. This is clearly visible, for example, in FIGS. 3, 4, and 6. The passage openings 27 are formed essentially cylindrical and moreover are used for the exact positioning of the fastening pins 11 during the installation.

The passage openings 27 of the support plate 26 are formed and arranged depending on the predefined attachment points in the crossbeam 107. This enables a connection of the fastening pins 11 with support plate 26 interposed. The support plate 26 is also used as a mounting aid, in addition to setting the exact vertical position of the fastening pins 11. The fastening pins 11 can be inserted beforehand in the support plate 26 and then arranged on the crossbeam 107 at the location of the attachment points. The fastening pins 11 are thus pre-positioned. Alternatively, the support plate 26 can be placed on the crossbeam 107, so that the passage openings 27 correspond with the attachment points on the crossbeam 107. The fastening pins 11 can then be inserted and connected to the crossbeam 107.

As is apparent in FIG. 1, the support plate 26 additionally comprises the mating part 16, in the opening 35 of which the engagement element 15a can engage to establish the second form fit. The mating part 16 is formed in one piece with the support plate 26. The opening 35 penetrates the mating part 16 in the vertical direction and is formed essentially complementary to the engagement element 15a.

Furthermore, it can be seen that the support plate 26 has two such mating parts 16, wherein one of the mating parts 16 is arranged on one of the longitudinal sides 49 of the support plate 26 in each case. The mating parts 16 are arranged in a middle area of the longitudinal sides 49 and oriented in opposite directions. Specifically, the mating parts 16 each have a lug 32, which protrudes beyond the longitudinal side 49 of the support plate 32. The lugs 32 are formed so that they have a distance from the surface or upper side of the crossbeam 107 the installed state of the support plate 26. In other words, a clearance is formed between the lugs 32 and the crossbeam 107, in which, for example, a further engagement element of a cover can engage.

The precise design, of whether support plates 26 having one or two mating parts 16 are used, is dependent on the respective position in the cargo compartment or cargo system. Two mating parts 16 are typically arranged on support plates 26 in the area of roller conveyor joints (one for each roller conveyor assembly) and support plates 26 having one mating part 16 are arranged in areas within roller conveyors 101 or components.

A rail section 34 is formed between the two mating parts 16. The rail section 34 forms a perforated rail which is used as a tiedown point. The perforated rail extends in the longitudinal direction of the support plate 26. The perforated rail is formed in one piece with the support plate 26.

Depending on the respective application, only one mating part 16 without rail section 34 can also be part of the support plate 26. Alternatively, the support plate 26 can be designed as a flat plate and the mating part 16 can be installed or fastened as a separate part at another point, but in the vicinity of the fastening pins 11.

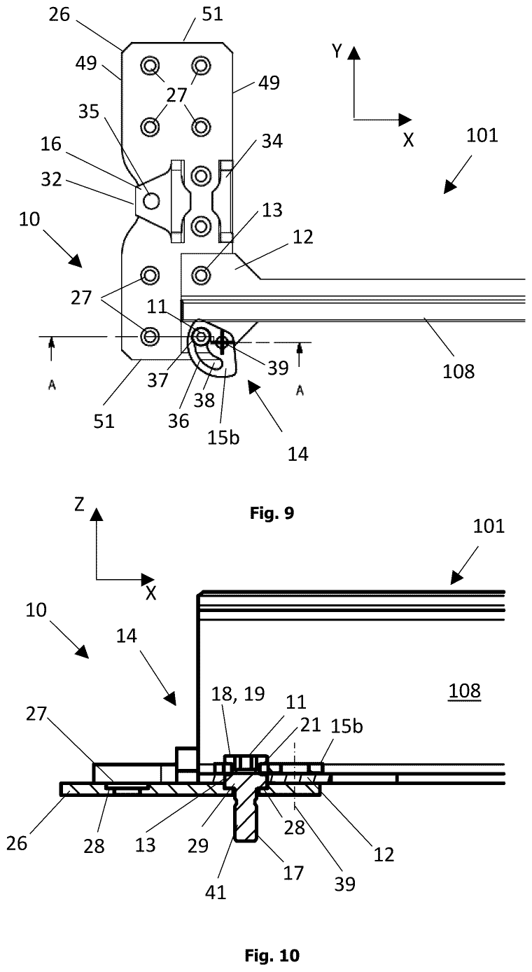

FIGS. 9 to 11 show a quick connection system 10 according to a further exemplary embodiment according to the invention. Only the differences of the quick connection system 10 from the quick connection system 10 according to FIGS. 1 to 8 are described hereinafter in order to avoid repetitions.

As can be seen clearly in FIG. 10, the seating section 29 of the fastening pin 11 has a thickness in the pin longitudinal axis direction which is greater than a respective thickness of the retaining section 18 and the guide section 21. Furthermore, it can be seen from FIG. 10 that the seating section 29 of the fastening pin 11 is seated in a formfitting manner not only in the passage opening 27 of the support plate 26, but also in the passage opening 13 of the connecting area 12. This applies to all fastening pins 11 which are connected to one of the connecting areas 12 of the roller conveyor 101. The passage opening 13 of the respective connecting area 12 and the respective corresponding passage opening 27 of the support plate 26 have the same diameter at least in the transition between the two openings in order to accommodate the seating section 29 in a formfitting manner. The external diameter of the seating section 29 essentially corresponds here to the adjacent internal diameters of the passage openings 13, 27.

If the roller conveyor 101 is placed on the fastening pins 11 with its connecting areas 12 over the passage openings 13, a first form fit is formed in both transverse directions with respect to the pin longitudinal axis LA. In both transverse direction means that the first form fit blocks a movement of the roller conveyor 101 in both X directions and in both Y directions. In this state, the roller conveyor 101 is already in its end position.

A further difference is that in the quick connection system from FIGS. 9 to 11, the passage openings 13 of the connecting areas 12 of the roller conveyor 101 are formed circular. Specifically, these passage openings 13 are formed as holes. These can be formed slightly larger than the diameter of the retaining section 18, in order to ensure guiding through of the retaining section 18 of the fastening pin 11 during the installation or removal.

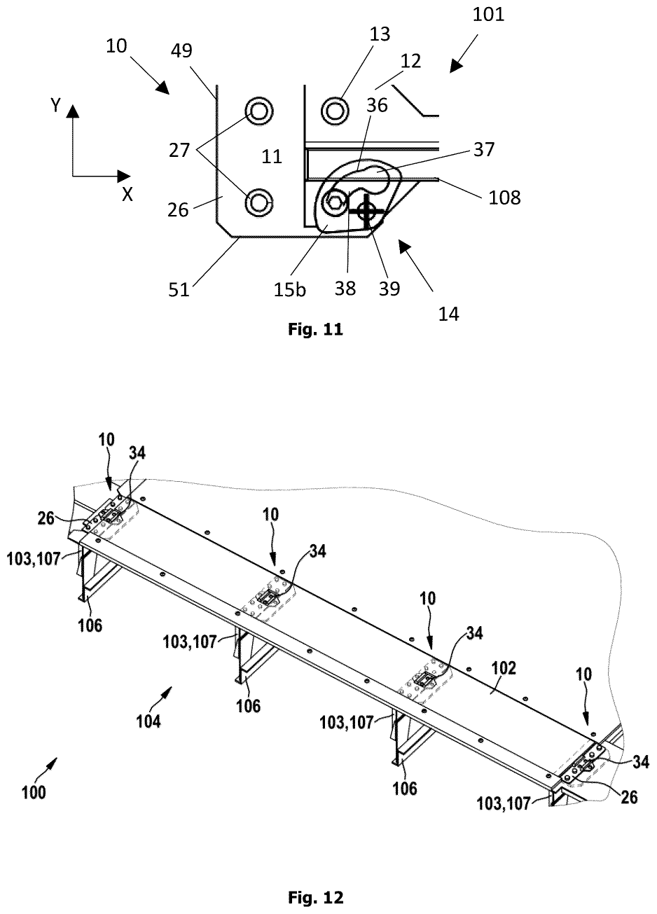

The retaining part 105 is absent in the quick connection system 10 from FIGS. 9 to 11. The locking mechanism 4 is also designed differently in this quick connection system 10 than in the quick connection system from FIGS. 1 to 8. As can be seen in FIGS. 9 and 11, the locking mechanism 14 has an engagement element 15b, which is formed disc-shaped. The engagement element 15b has a curved opening 36 for locking the fastening pin 11. The curved opening 36 comprises a first opening area 37, which is larger than the diameter of the retaining section 18 of the respective fastening pin 11. Furthermore, the curved opening 36 comprises a second adjacent opening area 38, which is smaller than the diameter of the retaining section 18, but is larger than or equal to the diameter of the guide section 21. A mobility of the engagement element 15b in relation to the fastening pin 11 is thus ensured, even if the guide section 21 is guided in the second opening area 38 of the curved opening 36.

The first opening area 37 has an internal diameter which essentially corresponds to the diameter of the retaining section 18 of the fastening pin 11, but is preferably slightly larger. The second opening area 38 is an elongated hole extending in a curve, which is open toward the first opening area 37.

The engagement element 15b is rotatable around an axis of rotation 39 that extends parallel to the pin longitudinal axis LA. In the positioned state of the roller conveyor 101, in which the first form fit is established, the axis of rotation 39 is offset in position in relation to the pin longitudinal axis LA. Specifically, the axis of rotation 39 is offset in relation to the pin longitudinal axis LA in both transverse directions.

The engagement element 15b is rotatable, in particular pivotable, between a first rotational position and a second rotational position on the axis of rotation 39. The first rotational position, which can be seen in FIG. 9, the first opening area 37 of the curved opening 36 corresponds with the pin longitudinal axis LA such that the connecting area 12 and therefore the roller conveyor 101 is released from the fastening pin 11. In the first rotational position, a form fit is therefore not formed between the fastening pin 11 and the engagement element 15b. The fastening pin 11 protrudes in a freestanding manner through the first opening area 37 of the curved opening 36.

In the second rotational position, which can be seen in FIG. 11, the engagement element 15b is pivoted around the axis of rotation 39, in particular clockwise, wherein the guide section 21 of the fastening pin 11 is inserted into the second opening area 38 of the curved opening 36 and stops on a longitudinal end of the opening area 38. In the second rotational position, the retaining section 18 protrudes beyond the engagement element 15b in the section of the engagement element 15b adjacent to the second opening area 38. In other words, the retaining section 18 overlaps the engagement element 15b at the second opening area 38 such that the retaining section 18 holds the engagement element 15b in the pin longitudinal direction LA.

Since the engagement element 15b is arranged between the connecting area 12 of the roller conveyor 101 and the retaining section 18 of the fastening pin 11, the second form fit is formed, which now prevents a movement of the roller conveyor 101 in the pin longitudinal axis direction, i.e. in the Z direction. The roller conveyor 101 is now in a completely locked state.

To release the roller conveyor 101 from the fastening pin 11, the engagement element 15b only has to be pivoted from the second to the first rotational position. The roller conveyor 101 is then removable very easily.

Furthermore, it can be seen in FIGS. 9 to 11 that the support plate 26 differs from that from FIGS. 1 to 6. The support plate 26 only has one mating part 16 in the present case. It is also possible that this support plate 26 can be used in the quick connection system 10 from FIGS. 1 to 8. This is also true for the plate 26 from FIGS. 1 to 6, which is alternatively usable in the quick connection system 10 from FIGS. 9 to 11. The design or embodiment of the support plate 26 having one or two mating parts 16 is dependent on the requirements of the component(s) used and in particular depends on the position, in particular in the X direction, for example, at which a roller conveyor joint is provided. At a roller conveyor joint, a support plate 26 having two mating parts 16 located in the area within a roller conveyor 101 is preferably used. This relates to the embodiments of the quick connection system 10 having a locking mechanism 14 from FIGS. 1 to 6 and from FIGS. 19 to 22. It is also possible that a support plate 26 having only one mating part 16 located in the area within a roller conveyor 101 can be used at a roller conveyor joint. This relates to the embodiment of the quick connection system 10 having a locking mechanism 14 from FIGS. 9 to 11. Other designs and combinations of support plates 26 at joints are possible.

FIGS. 12 to 14 show a quick connection system 10 in a further preferred embodiment, wherein instead of a roller conveyor 101, as is provided in the exemplary embodiments from FIGS. 1 to 11, a cover 102 is releasably connected to the crossbeams 107 via several of the quick connection systems 10. The cover 102 is shown transparent in FIGS. 12 and 13 for better illustration of underlying parts.

It can be seen clearly in FIG. 13 that the support plate 26 of the quick connection system 10 is identical to the support plate 26 from FIGS. 1 to 6. The fastening pins 11 are also identical to the fastening pins 11 from FIGS. 1 to 7. Alternatively or additionally, the fastening pins 11 from FIGS. 9 to 11 can be used. The cover 102 is compatible with all described fastening pins 11.

The cover 102 is formed elongated and has multiple connecting areas 12, which corresponds to a surface of the cover 107 located on the bottom in the installed position. The respective connecting area 12 has multiple passage openings 13, which are covered on top in the installed position. In other words, the passage openings 13 are not to be understood as a perforation at the connecting area 12, but rather as an opening in the sense of a pocket hole. This has the advantage that dirt cannot collect in the passage openings and damage can be avoided in the installed state. They are simply referred to as openings 13 hereinafter. The openings 13 have an internal diameter which essentially corresponds to the diameter of the retaining section 18 and, for example, the diameter of the seating section 29 if the seating section 29 should protrude beyond the support plate 26. By pushing on the cover 102 by means of accommodating the part of the fastening pin 11 protruding beyond the support plate 26, a first form fit is formed, which blocks a movement of the cover 102 in both transverse direction, i.e. in both X and Y directions.

In the quick connection system 10 from FIGS. 12 to 14, the locking mechanism 14 has an engagement element 15c which is formed disc-shaped. The engagement element 15c has a curved external contour 31 in some sections. The engagement element 15c is arranged so it is pivotable on a lower side of the cover 102, which faces away from the cargo compartment in the installed state. The engagement element 15c is rotatable around an axis of rotation 39 which, when the first form fit is formed, extends parallel to the pin longitudinal axis LA. In the attached state of the cover 102, in which the first form fit is established, the axis of rotation 39 is offset in position in relation to the pin longitudinal axis.

The engagement element 15c is rotatable, in particular pivotable, between a first rotational position and a second rotational position at the axis of rotation 39. In the first rotational position, which can be seen in FIG. 13, the engagement element 15c is pivoted with its curved external contour 31 into the clearance formed between the lug 32 of the mating part 16 and the surface of the crossbeam 107. In other words, the curved external contour 31 of the engagement element 15c is located in some sections below the lug 32, so that a second form fit is formed which prevents raising of the cover 102. The second form fit thus blocks a movement of the cover 102 in the pin longitudinal axis direction LA, i.e. in the Z direction. The cover 102 is in a completely locked state here.

To release the cover 102 from the fastening pins 11, the engagement element 15c only has to be pivoted from the second to the first rotational position. In the second rotational position, the engagement element 15c does not engage in the clearance. The cover 102 is then removable very easily.

Since the cover 102 having its openings 13 is formed so that the fastening pins 11 according to both exemplary embodiments can be accommodated, refitting between a cargo compartment having freight system components, such as the above-described roller conveyor, or a cargo compartment in “bulk configuration” i.e. having flat floor, can take place without great effort. The cover 102 is preferably used in a cargo compartment in “bulk configuration”.

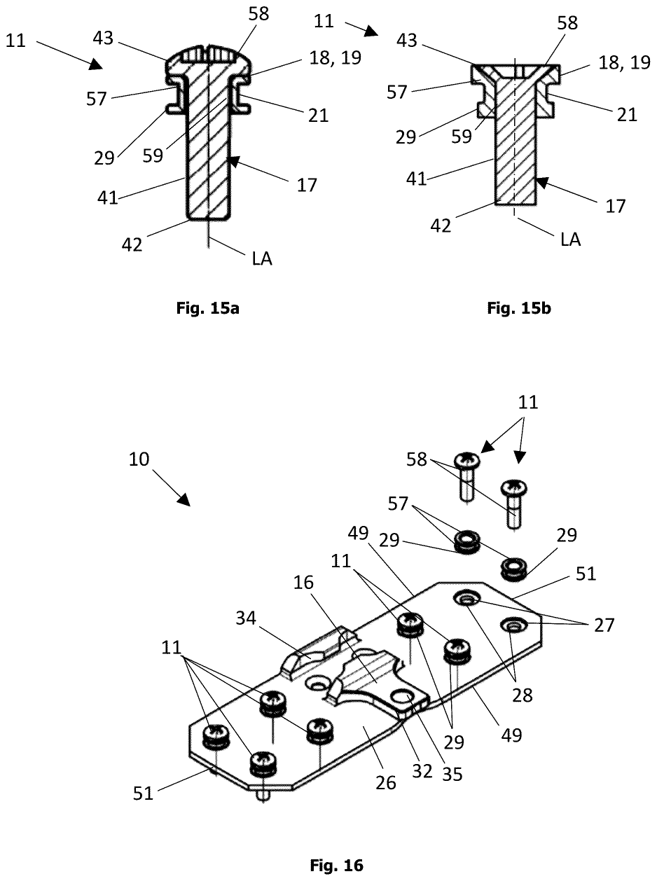

Two further exemplary embodiments of one or more fastening pins 11 for one or more of the quick connection systems 10 according to the exemplary embodiments according to the invention are shown in FIGS. 15a and 15b.

The fastening pins 11 from FIGS. 15a and 15b, in contrast to the fastening pins 11 from FIG. 11, are formed in two parts. The design of the fastening pins 11 will be explained in more detail on the basis of FIGS. 15a and 15b, wherein the following description of the fastening pin 11 applies to all two-part fastening pins 11. Differences between the two fastening pins 11 from FIGS. 15a and 15b are highlighted separately.

The fastening pin 11 from FIG. 15 a, b has an elongated base body 17. The elongated base body 17 comprises a fastening section 41 having an external thread, which extends along the pin longitudinal axis LA. As is apparent, the external thread tapers toward a first longitudinal end 42 of the fastening pin 11. The fastening pin 11 is connected to the crossbeam 107 via the fastening section 41.

The elongated base body 17 of the fastening pin 11 from FIGS. 15a, 15b is part of a screw. In FIG. 15a, the screw 58 is a panhead screw and in FIG. 15b, the screw 58 is a countersunk screw. In general, the use of other types of screws is possible.

Furthermore, the fastening pin 11 from FIG. 15 a, b has a sleeve 57 having a passage 59. The sleeve 59 can be pushed onto the screw 58 or pushed on as shown in FIG. 15a, b. The sleeve 57 comprises a retaining section 18, which protrudes outward transversely to the pin longitudinal axis LA. The retaining section 18 is used in the fastened state of the roller conveyor 101 to fix a connecting area 12 of the roller conveyor 101 in a direction parallel to the pin longitudinal axis LA while forming a form fit. This direction is also referred to as the pin longitudinal axis direction, which corresponds to a Z direction. In the present example, the pin longitudinal axis direction extends parallel to the Z direction of the aircraft. The retaining section 18 is arranged at a second longitudinal end 43 of the fastening pin 11. Specifically, the retaining section 18 forms a collar 19, which is formed circumferentially around the entire sleeve 57 with respect to the pin longitudinal axis LA.

FIG. 15 a, b furthermore show a guide section 21 of the fastening pin 11 adjacent to the collar 19. The guide section 21 is formed along the pin longitudinal axis LA next to the collar 19. The guide section 21 is used to guide the connecting area 12 of the roller conveyor 101 during a fastening procedure of the roller conveyor 101. The guide section 21 has a lesser width transverse to the pin longitudinal axis LA than the collar 19.

A seating section 29 of the fastening pin 11 is formed adjacent to the guide section 21. The seating section 29 protrudes beyond the guide section 21 transversely to the pin longitudinal axis LA. The seating section 29 forms a further circumferential collar on the sleeve 57. The seating section 29 is used for the seating in a passage opening, for example, of a support plate or bottom plate.

As shown in FIG. 15a, the seating section 29 and the retaining section 18 have the same width transversely to the pin longitudinal axis LA. Specifically, the seating section 29 and the retaining section 18 protrude by the same distance beyond the guide section 21 transversely to the pin longitudinal axis LA. As shown in FIG. 15b, in contrast, the retaining section 18 is somewhat greater in its width in comparison to the seating section 29. This is because the countersunk screw is countersunk on the head side in the sleeve 57 or is accommodated thereby. To enable this, the retaining section 18 is widened, so that the chamfer on the radial inside can be formed to accommodate the screw head. In principle, however, there is the possibility of adapting the retaining section 18 so that it has a width which corresponds to that of the seating section 29. In other words, the retaining section 18 and the seating section 29 can also have the same width in the fastening pin 11 from FIG. 15b.

In FIGS. 15a and 15b, the guide section 21 is arranged between the retaining section 18 and the seating section 29. Specifically, the guide section 21 forms a circumferential groove around the pin longitudinal axis LA in the sleeve 57, in particular the sleeve body.

As is clearly visible in FIG. 15 a, b, the fastening pin 11 is formed essentially cylindrical. The retaining section 18 and the guide section 21 each have a diameter, wherein the diameter of the retaining section 18 is larger than the diameter of the guide section 21. The seating section 29 likewise has a diameter which is larger than the diameter of the guide section 21.

FIG. 16 shows the support plate 26 from FIGS. 9-11 in combination with fastening pins 11 which correspond to the fastening pin 11 from FIG. 15a. It is also possible that the fastening pins 11 from FIG. 15b are used in the design shown in FIG. 16. A combination of fastening pins 11 from FIGS. 15a and 15b and FIG. 7 is possible.

The passage opening 27 of the support plate 26 comprise, as described above, a shoulder 28, on which the sleeves 57 of the fastening pins 11 rest with their seating sections 29. The seating section 29 of the sleeves 57 of the fastening pins 11 is accommodated in a formfitting manner in the respective passage opening 27 such that, for example, it terminates flush with an upper surface of the support plate 26. The connecting areas 12 of the roller conveyor 101 thus rest flatly on the support plate 26 for example, it is possible that the seating section 29 of the sleeves 57 is formed so that in the state arranged in the passage openings 27, it is offset downward from the upper surface of the support plate 26. Alternatively, a protrusion of the seating sections 29 above the surface of the support plate 26 can also be possible.

During the installation, the sleeves 57 are inserted with their seating sections 29 into the passage openings 27 so that they rest on the shoulders 28. The sleeves 57 are thus accommodated in a formfitting manner in the passage openings 27 and prepositioned. This enables rapid and easy fastening of the support plate on a structural part 103 of the aircraft structure 104. The screws 57 can then be inserted into the sleeves 57, wherein the sleeve 57 simplifies the screw connection of the screws 58 by guiding and holding.

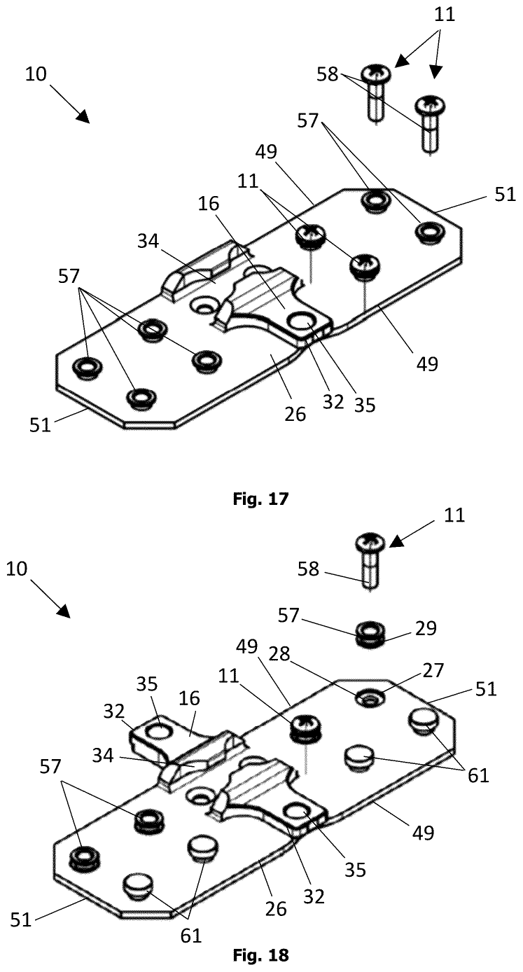

FIG. 17 shows a further embodiment of a support plate 26, wherein it differs from the support plate 26 from FIG. 16 in that the sleeves 57 are not arranged as separate parts on the support plate 26, but rather form an integral part of the support plate 26. In other words, the sleeves 57 are formed monolithically with the support plate 26. As can be seen in FIG. 17, the seating section 29 of the sleeves 57 is thus omitted, since pre-positioning as shown in FIG. 16 is not required. Nonetheless, the sleeves 57 function as part of the fastening pins 11.

The support plate 26 shown in FIG. 18 again makes use of the principle of the sleeves 57 as a component separate in each case (from the support plate), which is first prepositioned in the passage openings 27 of the support plate 26 and is then firmly screwed together with a structural part 103 of the aircraft structure 104 by inserting the screws 58.

FIG. 18 shows that the support plate 26 essentially corresponds to the support plate 26 from FIGS. 1-6, with the only difference that integrally formed locking bolts 61 are provided at the position of the passage openings 27 on one of the two longitudinal sides 49 instead of the passage openings 27. The locking bolts 61 protrude on the surface of the support plate 26. They preferably extend parallel to the pin longitudinal axis direction. The locking bolts 61 are formed mushroom-shaped and are used, in particular exclusively, for positioning a component, such as a cover, and transmitting downward loads, i.e. in the Z direction downward. The locking bolts 61 are preferably produced on the support plate 26 by milling. Higher tensile and transverse loads can and will not be transmitted by the locking bolts 61, since these would simply not withstand such loads.

FIGS. 19 to 22 show a further embodiment of a locking mechanism 14, which can be used in the quick connection system 10 according to one or more of the above-described exemplary embodiments according to the invention.

The locking mechanism 14 has an engagement element 15a, rotating handle 53, and a spring element 25. The engagement element 15a is formed bolt-shaped. In other words, the engagement element 15a is formed as cylindrical. Other shapes are possible. The engagement element 15a is translationally guided, though so it is longitudinally displaceable, in a retaining part 105, for example, of a roller conveyor 101. The retaining part 105 extends transversely to the longitudinal direction of the roller conveyor 101 between the two opposing roller conveyor profiles 108, which are not shown for the sake of simplicity. The retaining part 105 is a web which connects the two roller conveyor profiles 108.

The retaining part 105 has a hole 44, in which the engagement element 15a is guided so it is longitudinally displaceable. The engagement element 15a can emerge from the hole 44 at a lower side 45 of the retaining part 105 and retract therein again. The position of the engagement element 15a is dependent on the position of the rotating handle 53, to which the engagement element 15a is connected in a rotationally-fixed manner.

The rotating handle 53 is arranged on an upper side 52 of the retaining part 105. The engagement element 15a comprises a center longitudinal axis, which forms an axis of rotation DA of the rotating handle 53. That is to say, the rotating handle 53 is therefore rotatable around the axis of rotation DA. The rotating handle 53 is formed essentially T-shaped.

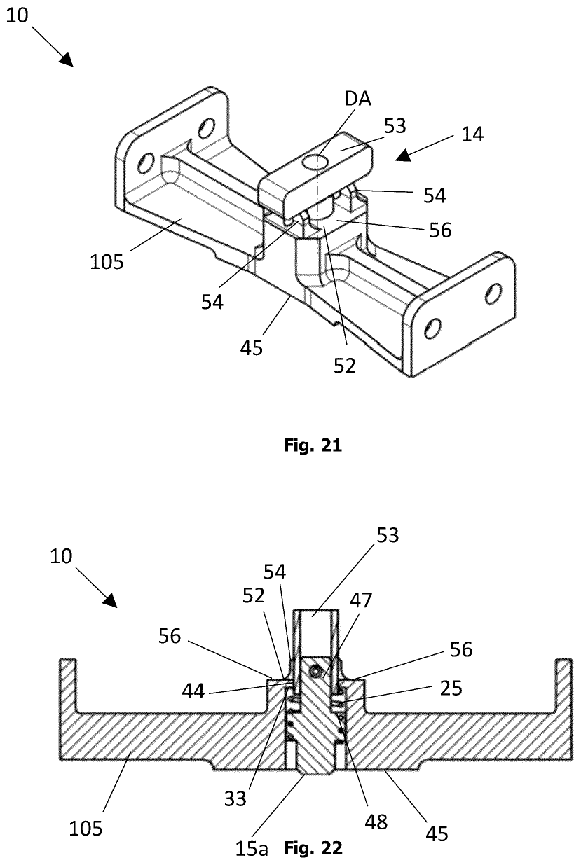

As can be seen clearly in FIGS. 19 and 21, the rotating handle 53 can adopt two handle positions. The handle positions correspond to rotational positions of the rotating handle in relation to the axis of rotation DA. The axis of rotation DA preferably extends vertically. In other words, the axis of rotation DA is perpendicular to the surface of the support plate 26.

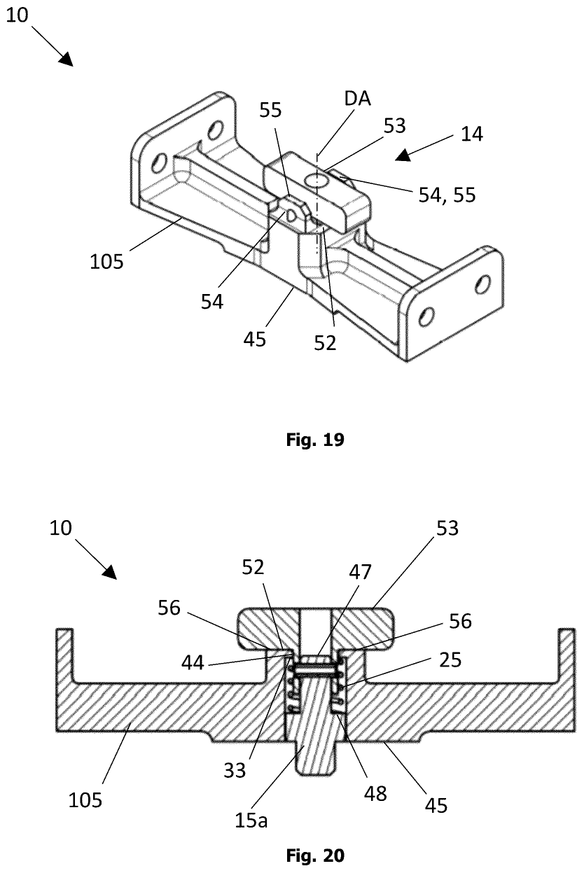

The engagement element 15a has a connecting pin 47, which is guided or can be guided through a perforation of the retaining part 105 toward the upper side 52. The engagement element 15a has a further portion in the hole 44, which has a greater width than the connecting pin 47. It can be seen clearly in FIGS. 20 and 22 that the engagement element 15a has a shoulder 48. It is also shown that the spring element 25 is supported on one side on an inner surface 33 of the hole 44 adjacent to the perforation and on the other side on the shoulder 48 of the engagement element 15a.

In a first handle position, the rotating handle 53 is aligned transversely to the retaining part 105. In the first handle position, the rotating handle 53 is rotated by 90° around the axis of rotation DA in relation to the retaining part 105. In the second handle position, the rotating handle 53 is aligned corresponding in direction with the retaining part 105. In other words, the rotating handle 53 is in a 0 position, in particular starting position, in the first handle position, in which the engagement element 15 a is raised, and is in a position rotated by 90° in relation to the 0 position in the second handle position, in which the engagement element 15a is lowered. The rotational angle range for raising and lowering the engagement element 15a is preferably 0° to 90° (around the axis of rotation DA).

As can be seen in FIG. 21, the rotating handle 53 extends essentially parallel to the longitudinal direction of the roller conveyor 101. In the first handle position, the wider portion of the engagement element 15a is completely accommodated in the hole 44, as shown in FIG. 22. In this position, the spring element 25 is compressed between the shoulder 48 of the engagement element 15a and the inner surface 33 of the hole 44 and thus applies a spring force which pre-tensions the engagement element 15a in the extension direction.

In the first handle position, the engagement element 15a is disengaged from an opening 35 of a mating part 16 (not shown), with which the second form fit can be formed, in order to block a movement of the roller conveyor 101 in the second transverse direction, specifically in the Y direction, and thus locked the roller conveyor 101 in its end position. In the second transverse direction means that the second form fit blocks a movement of the roller conveyor 101 in both Y directions.

Due to the alignment of the rotating handle 53 in the first handle position, the rotating handle 53 rests with a lower surface facing toward the engagement element 15a on two extensions 54 arranged opposite to the engagement element 15a, specifically on the upper edges 55 thereof. The spring force presses the rotating handle 53 against the upper edges 55 of the extensions 54, so that the rotating handle 53 is held, in particular in a friction-locked manner, in the first handle position.

To transfer the rotating handle 53 from the first handle position to the second handle position, it can be raised, acting against the spring of the spring force, and a direction leading away from the upper edges, so that the rotating handle 53 is freely rotatable around the axis of rotation DA. By subsequently rotating the rotating handle 53 by 90° in relation to the axis of rotation DA, the engagement element 15a is lowered during the transfer from the first of the second handle position, by which the second form fit is formed. The rotating handle 53 is located in some sections in the second handle position between the two extensions 54, which then fix the rotating handle 53 in its rotational position. The extensions 54 act in the second handle position as two lateral stops, which prevent or block a rotational movement of the rotating handle 53. In the second handle position, the rotating handle 53 rests with the lower surface on a surface 56 of the retaining part 105 set back in relation to the upper edges 55 of the extensions 54. The first handle position is shown in FIGS. 21 and 22, whereas the second handle position is shown in FIGS. 19 and 20.

During the transfer from the second to the first handle position, the engagement element 15a is raised, so that the second form fit is canceled and the roller conveyor 101 is displaceable via the keyhole-shaped passage openings 13 of the connecting areas 12 transversely to the longitudinal direction of the roller conveyor 101.

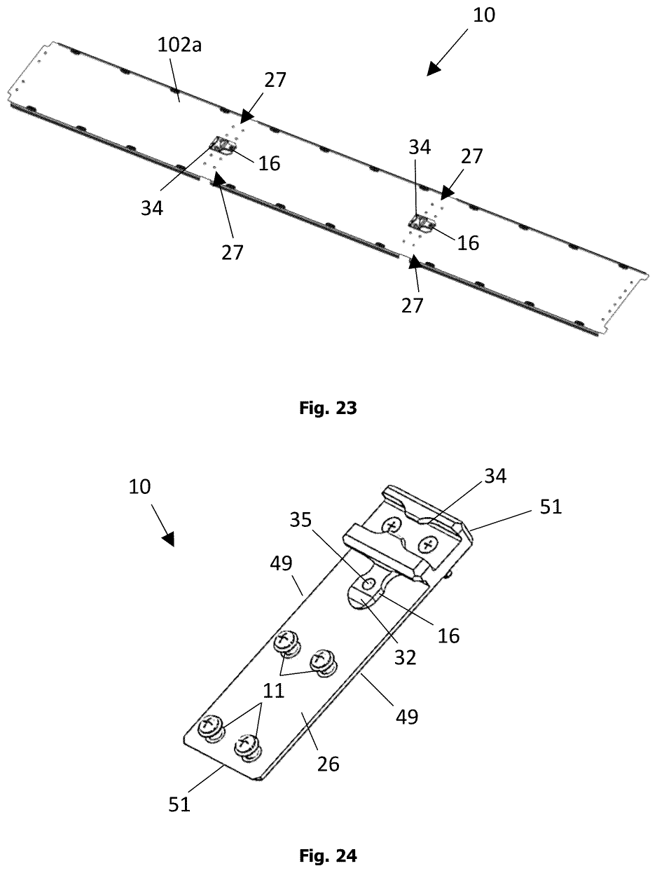

FIG. 23 shows a bottom plate 102a, which forms an enlarged support plate having multiple mating parts 16. The bottom plate 102a can also be referred to as a bottom cover. The bottom plate 102a has, at the positions of the structural parts 103 of the aircraft structure 104, a hole pattern of the passage openings 27 of the support plate 26 in order to position fastening pins 11 and fasten a component, such as a roller conveyor 101, at these structural part positions. The mating parts 16 (tiedown points) are screwed together with the bottom plate 102a in this case. They can also be firmly connected to the bottom plate 102a in another way. If the bottom plate 102a is used, the support plate 26 can be omitted as described above.

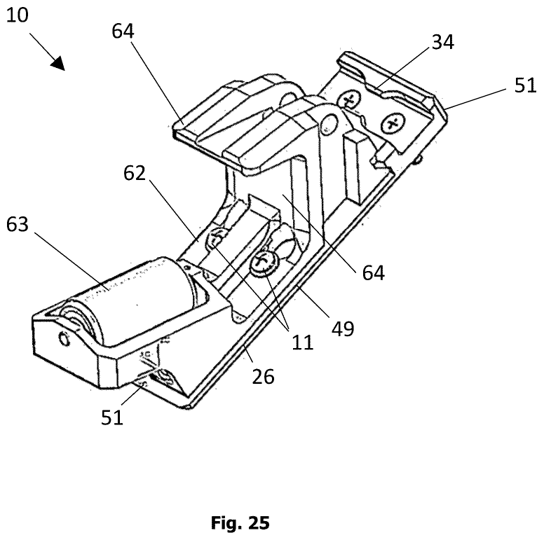

FIG. 24 shows a support plate 26 having fastening pins 11 already inserted into the passage openings 27, which are in two parts, i.e. comprise a screw 58 and a sleeve 57. A mating part 16 is provided at one longitudinal end of the support plate 26. FIG. 25 shows a latch 62, in particular a YZ latch, as the component 101. The latch 62 is connected via its connecting area 12, which has essentially keyhole-shaped openings as in the connecting area 12 from FIGS. 1 to 8, to the fastening pins 11 while forming a first form fit. The quick connection system 10 shown furthermore has a spring pre-tensioned handle (not shown), which can transfer an engagement element 15a from a locked position into an unlocked position and vice versa. The locking mechanism 14 used here functions according to the same principle as the locking mechanism 14 from FIGS. 1 to 8 and FIGS. 19 to 22.

It can furthermore be seen from FIG. 25 that the latch 62 has a roller 63, in order to move pieces of cargo, in particular containers or pallets, in a cargo compartment 100 in the X direction of the aircraft. The latch 62 itself is used to absorb forces in the Y direction, in particular the transverse direction which is perpendicular to the X direction, and in the Z direction, in particular the vertical direction which is perpendicular to the X/Y direction, and transmit them to the aircraft structure 104. The latch 62 therefore secures a piece of cargo in the Y and Z direction of the aircraft in use. For this purpose, the latch 62 has a stop surface 64, which provides a stop for the piece of cargo in the Y direction. Furthermore, the latch 62 has a lug 65 adjacent to the stop surface 64, which enables overlapping or engaging over a section of a piece of cargo in the Z direction and thus provides fastening in the Z direction.

For example, a change from a cargo compartment having flat floor (“bulk configuration”) to a cargo compartment having cargo loading system and vice versa is implementable by the quick connection system. During a configuration change from a cargo compartment having cargo loading system (“CLS configuration”) to a cargo compartment having flat floor, in particular without cargo loading system (“bulk configuration”), the latches 62 are replaced by flat covers, which use the same fastening principle by means of the fastening pins 11 and, for example, at least one locking mechanism. These covers are fastened via the mushroom-shaped design of the fastening pins 11 and a spring-loaded engagement element of the locking mechanism. The engagement element is integrated flatly in the cover in this case and can be unlocked by means of a tool, such as a screwdriver.

It is to be noted at this point that the described roller conveyors 101 can be connected to the crossbeams 107 using one or more quick connection systems according to FIGS. 1 to 8 and/or from FIGS. 9 to 11 and/or from FIGS. 15a to 22. The cover 102 can also have one or more of the quick connection systems according to FIGS. 12 to 14 and/or 23. Each component is particularly preferably releasably fastened at least on two crossbeams 107 spaced apart in the longitudinal direction of the aircraft, i.e. in the X direction.

The different fastening versions are also dependent on the loads to be introduced. The system from FIGS. 1-8 and FIGS. 15-22 is designed for transmitting cargo system loads in the X, Y, and Z directions, the locking in FIGS. 9-11 primarily for fastening covers which are to be held as flatly as possible and in position and to transmit X/Y shear loads and maximum downward loads in this case.

### LIST OF REFERENCE SIGNS

10 quick connection system
11 fastening pin
12 connecting area
13 passage opening of the connecting area
14 locking mechanism
15a-c engagement element
16 mating part
17 elongated base body
18 retaining section of the fastening pin
19 collar
21 guide section of the fastening pin
22 first opening area of the passage opening of the connecting area
23 second opening area of the passage opening of the connecting area
24 lever
25 spring element
26 support plate
27 passage opening of the support plate
28 shoulder
29 seating section of the fastening pin
31 curved external contour
32 lug of the mating parts
33 inner surface
34 rail section
35 opening of the mating part
36 curved opening
37 first opening area of the curved opening of the engagement element
38 second opening area of the curved opening of the engagement element
39 axis of rotation
41 fastening section of the fastening pin
42 first longitudinal end of the fastening pin
43 second longitudinal end of the fastening pin
44 hole of the retaining part
45 lower side of the retaining part
46 pivot joint
47 connecting pin
48 shoulder
49 longitudinal sides of the support plate
51 wide sides of the support plate
52 upper side of the retaining part
53 rotating handle
54 extension
55 upper edge
56 set-back surface
57 sleeve
58 screw
59 passage
61 locking bolt
62 latch
63 roller
64 stop surface
65 lug
100 cargo compartment
101 cargo system component, roller conveyor
102 cover
103 structural part
104 aircraft structure
105 retaining part
106 frame
107 crossbeam
108 roller conveyor profile
LA pin longitudinal axis
DA axis of rotation

1. A quick connection system for fastening and/or changing components of an aircraft cargo compartment on at least one structural part of an aircraft structure, comprising:
at least one fastening pin, installable on the structural part, having a pin longitudinal axis;
at least one connecting area, which is arranged or formed on the component and has at least one passage opening, in which the fastening pin can be accommodated or is accommodated at least in sections while forming a first form fit in the pin longitudinal axis direction and/or transversely to the pin longitudinal axis; and
at least one locking mechanism arranged on the component having at least one engagement element, which is movably mounted on the component such that, by a translational or rotational movement of the engagement element, a second form fit can be formed or is formed with the fastening pin, the structural part, or a mating part installable on the structural part, which blocks a movement of the component in the pin longitudinal axis and/or transversely to the pin longitudinal axis.

2. The quick connection system according to claim 1, wherein the fastening pin has an elongated base body having at least one retaining section, which protrudes transversely to the pin longitudinal axis on the base body in order to form the first form fit with the connecting area or to form the second form fit with the engagement element.

3. The quick connection system according to claim 1, wherein the fastening pin or several of the fastening pins is or are fastened directly to or on the structural part by screws in the installed state.

4. The quick connection system according to claim 2, wherein the retaining section of the fastening pin comprises at least one collar, which is formed at least partially circumferentially with respect to the pin longitudinal axis.

5. The quick connection system according to claim 2, wherein the base body has a guide section, which is adjacent to the retaining section and has a lesser width than the retaining section.

6. The quick connection system according to claim 5, wherein the retaining section has a first diameter and the guide section has a second diameter, and wherein the first diameter of the retaining section is larger than the second diameter of the guide section.

7. The quick connection system according to claim 2, wherein the passage opening of the connecting area is adapted to accommodate the retaining section and/or at least a portion of the base body while forming the first form fit.

8. The quick connection system according to claim 2, wherein the passage opening of the connecting area has a first opening area and an adjacent second opening area, which merge into one another, wherein the first opening area is designed so that the retaining section of the fastening pin can be guided through and the second opening area is designed so that the retaining section protrudes outward beyond the second opening area.

9. The quick connection system according to claim 1, wherein the passage opening of the connecting area is keyhole-shaped, elongated hole-shaped, or circular.

10. (canceled)

11. (canceled)

12. The quick connection system according to claim 1, wherein the locking mechanism comprises a lever, which is rotatably connected to the engagement element, wherein the lever, in a first lever position, raises the engagement element transversely to the pin longitudinal axis direction to release the second form fit, and, in a second lever position, lowers the engagement element transversely to the pin longitudinal axis direction to form the second form fit.

13. The quick connection system according to claim 1, wherein the locking mechanism comprises a rotating handle, which is connected in a rotationally-fixed manner to the engagement element, wherein the rotating handle, in a first handle position, raises the engagement element transversely to the pin longitudinal axis direction to release the second form fit, and, in a second handle position, lowers the engagement element transversely to the pin longitudinal axis direction to form the second form fit.

14. The quick connection system according to claim 13, wherein the locking mechanism has at least one extension having a protruding upper edge, which holds the rotating handle in its first handle position, and has at least one surface set back from the upper edge, on which the rotating handle rests in its second handle position.

15. (canceled)

16. (canceled)

17. The quick connection system according to claim 1, wherein at least one support plate and/or at least one bottom plate for supporting the component is provided, which comprises/comprise at least one passage opening for the fastening pin.

18. The quick connection system according to claim 17, wherein the passage opening of the support plate or the bottom plate has at least one shoulder and the fastening pin has at least one seating section, which rests on the shoulder and is accommodated in a formfitting manner in the passage opening of the support plate or the bottom plate.

19. (canceled)

20. The quick connection system according to claim 17, wherein the mating part for engaging the engagement element is part of the support plate, is fastened on the bottom plate, or is arranged in the vicinity of the fastening pin.

21. The quick connection system according to claim 17, wherein the support plate or the bottom plate has at least one hole pattern section for forming a tiedown point or positioning fitting, which is arranged in the area of the opening of the mating part.

22. The quick connection system according to claim 5, wherein the retaining section and/or the guide section of the fastening pin are formed in one piece with its base body or the retaining section and/or the guide section of the fastening pin are part of a sleeve separate from the base body.

23. (canceled)

24. (canceled)

25. (canceled)

26. (canceled)

27. (canceled)

28. A cargo compartment for an aircraft having at least two frames, which have a distance from one another in a longitudinal direction of the cargo compartment, and at least two crossbeams forming structural parts, wherein one of the crossbeams extends at each of the frames transversely to the longitudinal direction of the cargo compartment, and at least one component, wherein at least one connection system according to claim 1 is provided, by which the component is releasably connected to at least one of the crossbeams.

29. An aircraft having a cargo compartment according to claim 28.

30. A method for reconfiguring a cargo compartment according to claim 28, wherein the component is in a state locked with the structural part, wherein in the method
the engagement element is moved away from the mating part or the structural part of the aircraft by a translational or rotational movement such that it is moved into an unlocked position to release the second form fit;
the component is moved into a release position by displacing the connecting area and the connecting area is removed from the fastening pin; and
a further component is placed on the at least one fastening pin and the engagement element of the locking mechanism of the further component is fastened in a formfitting manner to the mating part or the structural part of the aircraft by a rotational movement of the engagement element.

31. (canceled)
